(19) United States
(12) Patent Application Publication
(10) Pub. No.: US 2010/0004975 A1
(43) Pub. Date: Jan. 7, 2010

(54) SYSTEM AND METHOD FOR LEVERAGING PROXIMITY DATA IN A WEB-BASED SOCIALLY-ENABLED KNOWLEDGE NETWORKING ENVIRONMENT

(76) Inventors: Scott White, Seattle, WA (US); Nova Spivack, San Francisco, CA (US)

Correspondence Address: PERKINS COIE LLP, P.O. BOX 1208, SEATTLE, WA, 98111-1208, US

(21) Appl. No.: 12/168,034

(22) Filed: Jul. 3, 2008

(51) Int. Cl. G06Q 10/00; G06N 5/02

(52) U.S. Cl. 705/10; 706/46

(57) ABSTRACT

Systems and methods for leveraging proximity data in a web-based socially-enabled information networking environment are disclosed. In one aspect, embodiments of the present disclosure include a method, which may be implemented on a system, of semantic advertising via semantic profiles. One embodiment can include, receiving a model profile from an advertiser, enforcing a set of rules that govern accessibility of the web content, parsing the model profile to obtain a first set of model user metadata associated with the ideal set of user characteristics, comparing model user metadata of the first set of model user metadata with user metadata of a set of user metadata of a semantic user profile of a user, and generating a correlation index to indicate a degree of correlation between the model profile and the semantic user profile.

### TECHNICAL FIELD

The present disclosure relates generally to knowledge networking, and in particular to leveraging proximity data in a web-based socially-enabled knowledge networking environment.

### BACKGROUND

Keyword based matching and identification has been the dominating mechanism for generating search results and providing recommendations. For example, search engines such as Google, Yahoo, MSN Search, AltaVista provide keyword entry fields for users to enter a keyword or a key phrase with which millions of documents and articles are compared. Although each search engine may process the documents and articles differently to determine relevancy, the matching and comparison algorithm is essentially keyword based.

Additionally, online shopping portals will frequently make recommendations to products or services based on the items that the user has purchased or has searched for. For example, Amazon.com will oftentimes recommend textbooks of a similar/same topic, novels written by the same author, CDs of the same/similar genre, etc. These recommendations are also usually identified based on keyword-based algorithms.

Advertisement placements are also generally provided based on keyword searches submitted by users, for example, in a search engine.

However, keyword-based identification and matching is limited in the relevancy of search results or recommendations provided to a user. Since same words can be used in different contexts, depending on the keyword or key-phrase submitted by the user, the search engine may need to analyze tens of thousands of documents with the same matching keyword. Furthermore, since many related concepts or ideas do not necessarily have the same identifying keywords, some search results or recommendations which are highly relevant may be missed by the traditional keyword-based search tools.

### BRIEF DESCRIPTION OF THE DRAWINGS

FIG. 1 illustrates a block diagram of a plurality of client devices able to communicate with a plurality of content providers and a server hosting a socially-enabled knowledge networking environment through a network, according to one embodiment.

FIG. 2 depicts a block diagram of the components of a host server for a socially-enabled knowledge networking environment, according to one embodiment.

FIG. 3A depicts a block diagram illustrating a database for storing user information of users (visitors and/or service subscribers) and a database for storing user group information, according to one embodiment.

FIG. 3B depicts a block diagram of a database for storing items, a database for storing emails, and a database for storing photographs, according to one embodiment.

FIG. 3C depicts a block diagram of a database for storing popular searches, a database for storing popular tags, a database for storing popular nets, and a database for storing nets (e.g., user nets), according to one embodiment.

FIG. 3D depicts a block diagram of a database for storing ontologies and a database for storing sponsorship or advertiser information, according to one embodiment.

FIG. 4A illustrates a diagrammatic representation of an example semantic graph compiled from user activity in the networking environment showing neighboring entities having a relationship of one degree and two degrees of separation with a central entity, according to one embodiment.

FIG. 4B illustrates a diagrammatic representation of an example semantic graph showing relative probabilities that correspond to the likelihood that a user associated with an entity will browse to a neighboring entity, according to one embodiment.

FIG. 5 illustrates an example screenshot of a graphical user interface displaying search results that are ranked based on proximity to the user, according to one embodiment.

FIG. 6 depicts tables illustrating examples of model profiles, according to one embodiment.

FIG. 7 depicts tables illustrating an example of a semantic user profile constructed from examples of context-independent, context-dependent, and temporal semantic user profiles, according to one embodiment.

FIG. 8 depicts a block diagram illustrating a system for leveraging proximity data in a web-based socially-enabled knowledge networking environment, the system includes a host server coupled to a user database, content provider, and/or a content database, according to one embodiment.

FIG. 9A illustrates an example screenshot of a graphical user interface for a user home page in the networking environment, including connections, items, tags, and/or events, according to one embodiment.

FIG. 9B illustrates an example screenshot of a graphical user interface displaying objects in a user net in the networking environment, according to one embodiment.

FIG. 10A depicts a flow diagram illustrating a process of determining the degree of correlation between a model profile and a semantic user profile, according to one embodiment.

FIG. 10B depicts a flow diagram illustrating a process for determining a correlation index that indicates the degree of correlation between the model profile and the semantic user profile, according to one embodiment.

FIG. 11A depicts a flow diagram illustrating a process for generating a semantic user profile, according to one embodiment.

FIG. 11B depicts a flow diagram illustrating a process for generating a context-independent semantic user profile, according to one embodiment.

FIG. 11C depicts a flow diagram illustrating a process for generating a context-dependent semantic user profile, according to one embodiment.

FIG. 11D depicts a flow diagram illustrating a process for generating a temporal semantic user profile, according to one embodiment.

FIG. 12A-B depict a flow diagrams illustrating an example process of determining proximity between a central entity and a target entity, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for leveraging proximity data, or proximity-related data in a web-based socially-enabled knowledge networking environment, for example, by compiling data (e.g., semantically) related to, but not limited to, user behavior and activity in the networking environment.

Some embodiments of the present disclosure include collecting proximity data (e.g., social proximity/distance data or semantic proximity/distance data) to improve the relevancy of, search, advertising, and generating recommendations, for example.

In a web-based environment, semantic user profiles can be constructed from user information collected based on different temporal scopes. For example, a context independent profile, a context dependent profile, and/or a temporal profile, etc. These time-based profiles are generally constructed from user behavior, activity, user profile, in a semantics-enabled web-based environment. The aggregate of these profiles, for example, in an application dependent-fashion, provide the basis for generating a semantic user profile. The aggregation is performed in an intelligent and adjustable manner, as will be further discussed to provide a suitable semantic representation of any given user and comparison mechanism with a model user. The semantic user profile can be utilized as a basis for comparison with a model profile provided by an advertiser/sponsor, or other promotional entity, for example, who wishes to identify a set of candidates to whom to present the promotional material.

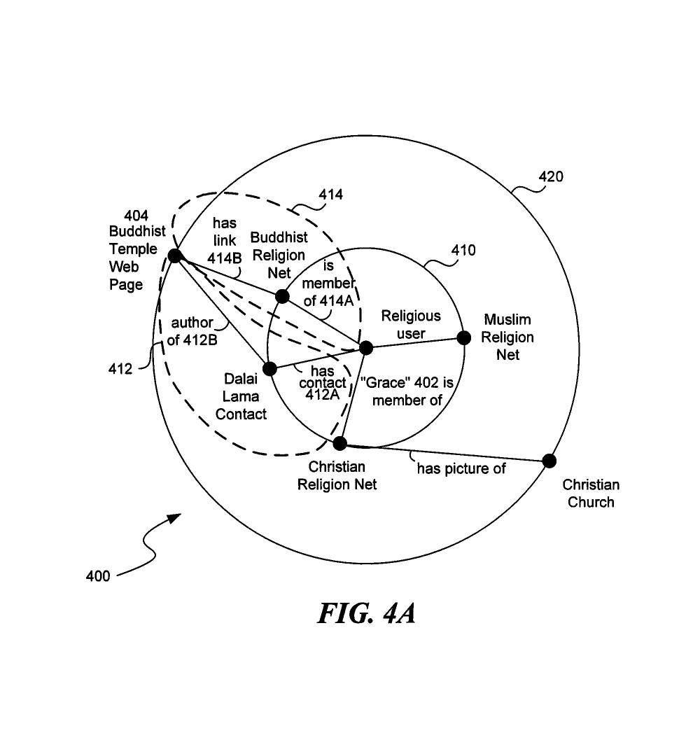

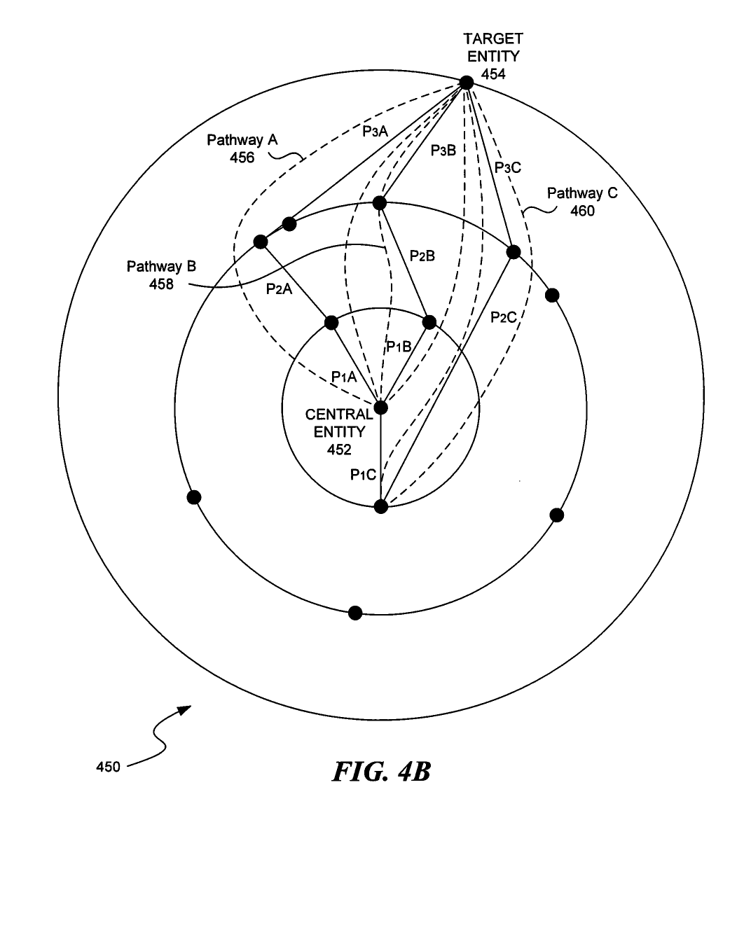

By virtue the semantics-enabled web-based environment being socially-enabled (e.g., users can connect with one another and share items), hereinafter referred to as “knowledge networking environment” or “socially-enabled knowledge networking environment”, semantic distance or social distance between uses and items in the network can be determined. These distances, hereinafter referred to as “proximity” or “proximity distance”, are, in one embodiment, used as a factor when comparing the semantic user profile to the model profile. For example, correlation between a given user can be increased or decreased dependent proximity distances, as is described in detail in association with FIG. 4-12.

The knowledge networking environment (otherwise referred to as knowledge networking environment) is a platform on which users can add, collect, distribute, and/or share information or items. The information and/or items shared include by way of example but not limitation, text submissions, emails, images, pictures, videos, etc. In addition, users can establish social relationships with other users in the networking environment. For example, users can connect with another user as a friend or other types of relationships. Depending on user settings or other situational factors, the establishment of a mutual social relationship in the networking environment enables each party to access certain items collected by each other.

Furthermore, the networking environment allows users to create web-spaces in the network, these web-spaces are otherwise referred to as ‘nets’ or ‘Twines’. Nets may be created as a special interest group where user can join as members and add/post items related to specific topics for sharing content. Nets can also be created for other purposes such as for promotional/advertisement purposes.

In general, the networking environment is built on a semantically-enabled platform such that system intelligence allows information about users, user relationships, items, specific topics to be collected and utilized. In a non-limiting example, user interest can be inferred from metadata gleaned from the items collected or items viewed. User profiles which include information explicitly provided by the user as well as implicit data inferred from user activity or behavior. Furthermore, user and/or group interest can further be refined by the existence of social connections and the types of relationships that form on the basis of social connections created in the networking environment.

The networking environment (e.g., knowledge networking environment) and the services and functions related thereof are described in detail with further references to U.S. patent application Ser. Nos. 11,874,881 and 11/874,882 both entitled “System and Method of a Knowledge Management and Networking Environment” and are herein incorporated by reference.

Users, items (objects), and/or nets can be referred to as ‘entities’ in the networking environment. Therefore, an entity is generally of or represents one of the following types: tangible entity, intangible entity, or software entity. A non-limiting example of a tangible entity would be a user in the network. Software entities can include, items added or collected by users, in a non-limiting example, an email, a video clip, a music stream, a note, a blog entry, a discussion forum, etc. Intangible entities can include concepts, ideas, opinions, comments, topics. In addition, a net can be considered an intangible entity.

The entities that exist in the socially-enabled knowledge networking environment are interrelated to at least some of the other entities. These relationships can include, by way of example, but not limitation, social relationships and/or semantic relationships. The relationships may be inherent or defined by actions and activities that occur in the networking environment.

Thus, in one embodiment, user semantic profiles are created for users in the networking environment. A user semantic profile is generally representative of a user's relationship with various entities in the network and accounts for relationships of various degrees of separation. For example, a user semantic profile could provide information related to, the nets to which the user belongs, people to whom the user is connected, items/entities that the user has viewed, collected, and/or shared, etc. Furthermore, the user semantic profile would be indicative of the types of semantic and/or social relationships of a user with other entities (e.g., items and/or users) in the networking environment. In one embodiment, the user semantic profile includes specifiers of the social and/or semantic proximity between the user and the other entities in the network.

Semantic user profiles may be generated from semantic user graphs for users in the network. The semantic user graph is generally created as a graphical means to visualize relationships and social separation of varying degrees between entities in the network. In one embodiment, the semantic graph can be used when computing the proximity between a user and another entity.

In one aspect, the present disclosure relates to semantic user profile-driven semantic advertising. The semantic user profiles created in the networking environment can in many ways provide enhanced targeted advertising services to advertisers due to the wealth of information collected about users. For example, information regarding relative strengths of tags that users are interested in, relative strengths of objects/ideas/concepts/entities that users are interested in, friends of users, membership in groups, proximity to various entities in the network.

The advertisers can provide an ideal set of user characteristics in a model profile of a model user having characteristics representative of the ideal user towards whom the advertisement is targeted. The model profile is then parsed and analyzed such that user profiles that are similar to or otherwise correlate strongly with can be identified. In some instances, the degree of correlation is a function of proximity between entities in the model profile and the semantic profile of a user.

In addition to enhanced advertising, the semantic user profiles can be utilized by the networking platform to enable improved relevancy of searches and recommendations (e.g. in both pull and push models).

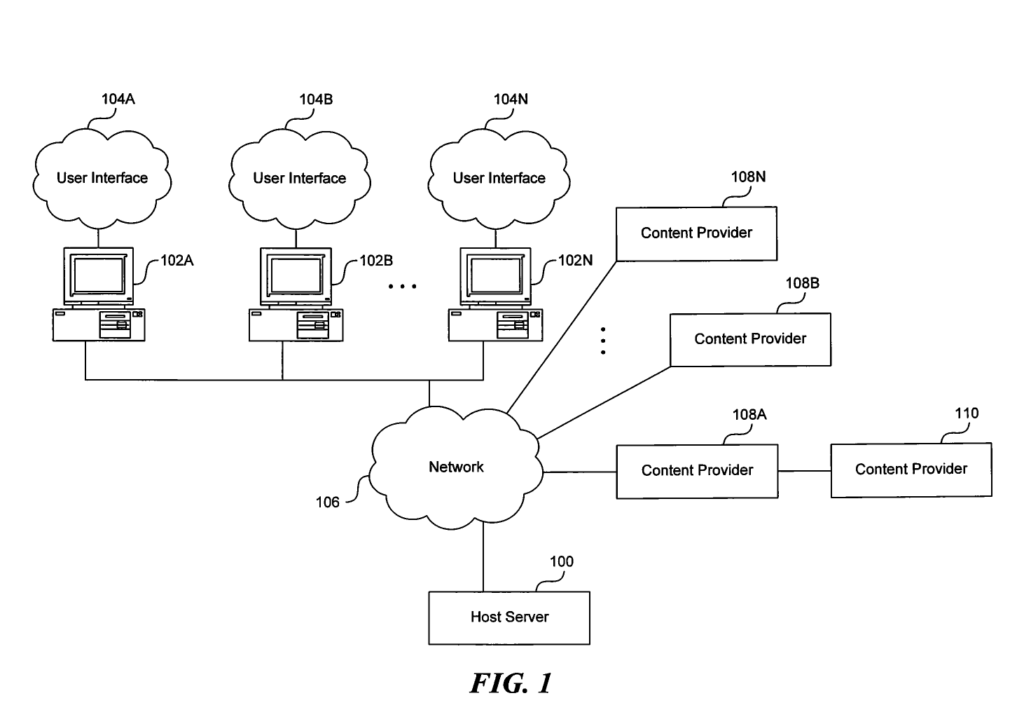

FIG. 1 illustrates a block diagram of a plurality of client devices 104A-N able to communicate with a plurality of content providers 108A-N, 110 and a server 100 hosting a socially-enabled knowledge networking environment through a network, according to one embodiment.

The plurality of client devices 104A-N and content providers 108A-N, 110 can be any system and/or device, and/or any combination of devices/systems that is able to establish a connection with another device, a server and/or other systems. The client devices 104A-N and content providers 108A-N, 110 typically include display or other output functionalities to present data exchanged between the devices to a user. For example, the client devices and content providers can be, but are not limited to, a server desktop, a desktop computer, a computer cluster, a mobile computing device such as a notebook, a laptop computer, a handheld computer, a mobile phone, a smart phone, a PDA, a Blackberry device, a Treo, and/or an iPhone, etc. In one embodiment, the client devices 104A-N and content providers 108A-N, 110 are coupled to a network 106. In some embodiments, the modules may be directly connected to one another.

The network 106, over which the client devices 104A-N and content providers 108A-N, 110 communicate, may be a telephonic network, an open network, such as the Internet, or a private network, such as an intranet and/or the extranet. For example, the Internet can provide file transfer, remote log in, email, news, RSS, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices, host server, and/or the content providers 108A-N, 110 and may appear as one or more networks to the serviced systems and devices. In one embodiment, communications to and from the client devices 104A-N and content providers 108A-N, 110 can be achieved by, an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more wireless networks, such as, but is not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

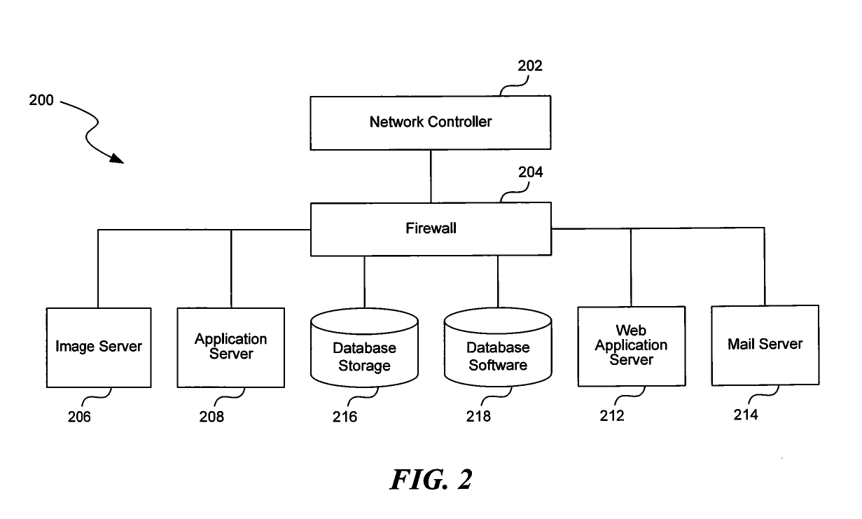

FIG. 2 illustrates a block diagram of the components of a host server 200 for a socially-enabled knowledge networking environment, according to one embodiment.

In the example of FIG. 2, the host server 200 includes a network controller 202, a firewall 204, an image server 206, an application server 208, a web application server 212, a mail server 214, and a database including a database storage 216 and database software 218.

In the example of FIG. 2, the network controller 202 can be a networking device that enables the host server 200 to mediate data in a network with an entity that is external to the host server, through any known and/or convenient communications protocol supported by the host and the external entity. The network controller 202 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The firewall 204, can, in some embodiments, govern and/or manage permission to access/proxy data in a computer network, and track varying levels of trust between different machines and/or applications. The firewall 204 can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall 204 may additionally manage and/or have access to an access control list which details permissions including for example, the access and operation rights of an object by an individual, a machine, and/or an application, and the circumstances under which the permission rights stand.

Other network security functions can be performed or included in the functions of the firewall 204, can be, for example, but are not limited to, intrusion-prevention, intrusion detection, next-generation firewall, personal firewall, etc. without deviating from the novel art of this disclosure. In some embodiments, the functionalities of the network controller 202 and the firewall 204 are partially or wholly combined and the functions of which can be implemented in any combination of software and/or hardware, in part or in whole.

In the example of FIG. 2, the host server 200 includes the image server 206 or a combination of image servers to manage images, photographs, animation, and/or other types of image data. The image server 206 is any web server software suitable for delivering messages to facilitate efficacious retrieval of image data in web servers to be provided to other components and/or systems of the host server 200, for example when rendering a web page with images. In addition, the image server 206 can facilitate streaming data such as streaming images and/or video. The image server 206 can be configured separately or together with the web application server 212, depending on a desired scalability of the host server 200. Examples of graphics file formats that can be managed by the image server 206 include but are not limited to, ADRG, ADRI, AI, GIF, IMA, GS, JPG, JP2, PNG, PSD, PSP, TIFF, and/or BMP, etc.

The application server 208 can be any combination of software agents and/or hardware modules for providing software applications to end users, external systems and/or devices. The application server 208 can facilitate interaction and communication with the web application server 212, or with other related applications and/or systems. The application server 208 can in some instances, be wholly or partially functionally integrated with the web application server 212. The web application server 212 is any combination of software agents and/or hardware modules for accepting Hypertext Transfer Protocol (HTTP) requests from end users, external systems, and/or external client devices and responding to the request by providing the requesters with web pages, such as HTML documents and objects that can include static and/or dynamic content (e.g., via one or more supported interfaces, such as the Common Gateway Interface (CGI), Simple CGI (SCGI), PHP, JavaServer Pages (JSP), Active Server Pages (ASP), ASP.NET, etc.).

In addition, a secure connection, SSL and/or TLS can be established by the web application server 212. In some embodiments, the web application server 212 renders the web pages having graphic user interfaces of the networking environment as shown in the example screenshots of FIG. 4-7. The web pages provided by the web application server 212 to client users/end devices enable user interface screens 104A-104N for example, to be displayed on client devices 102A-104N. In some embodiments, the web application server 212 also performs an authentication process before responding to requests for resource access and data retrieval.

In one embodiment, the host server 200 includes a mail server 214 including software agents and/or hardware modules for managing and transferring emails from one system to another, such as but is not limited to Sendmail, Postfix, Microsoft Exchange Server, Eudora, Novell NetMail, and/or IMail, etc. The mail server 214 can also store email messages received from the network. In one embodiment, the mail server 214 includes a storage component, a set of access rules which may be specified by users, a list of users and contact information of the users' contacts, and/or communication modules able to communicate over a network with a predetermined set of communication protocols.

The databases 216, 218 can store software, descriptive data, images, system information, drivers, and/or any other data item utilized by other components of the host server for operation. The databases 216, 218 may be managed by a database management system (DBMS), for example but not limited to, Oracle, DB2, Microsoft Access, Microsoft SQL Server, PostgreSQL, MySQL, FileMaker, etc. The databases 216, 218 can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package.

In the example of FIG. 2, the host server 200 includes components (e.g., a network controller, a firewall, a storage server, an application server, a web application server, a mail server, and/or a database including a database storage and database software, etc.) coupled to one another and each component is illustrated as being individual and distinct. However, in some embodiments, some or all of the components, and/or the functions represented by each of the components can be combined in any convenient or known manner. Furthermore, the functions represented by the devices can be implemented individually or in any combination thereof, in hardware, software, or a combination of hardware and software.

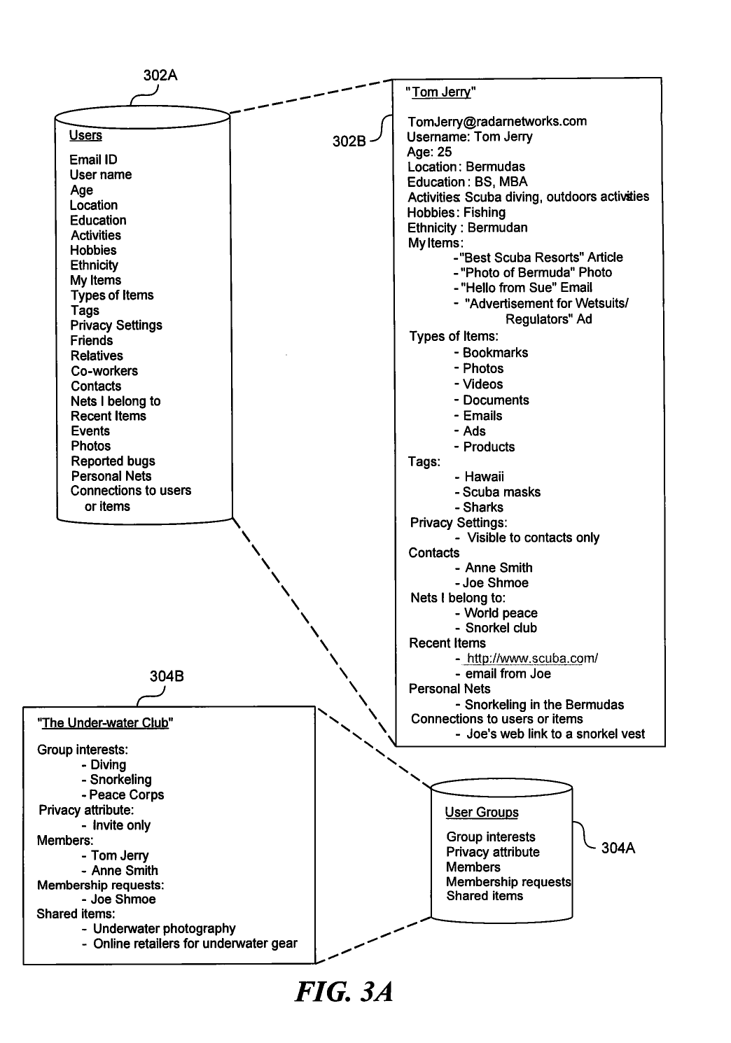

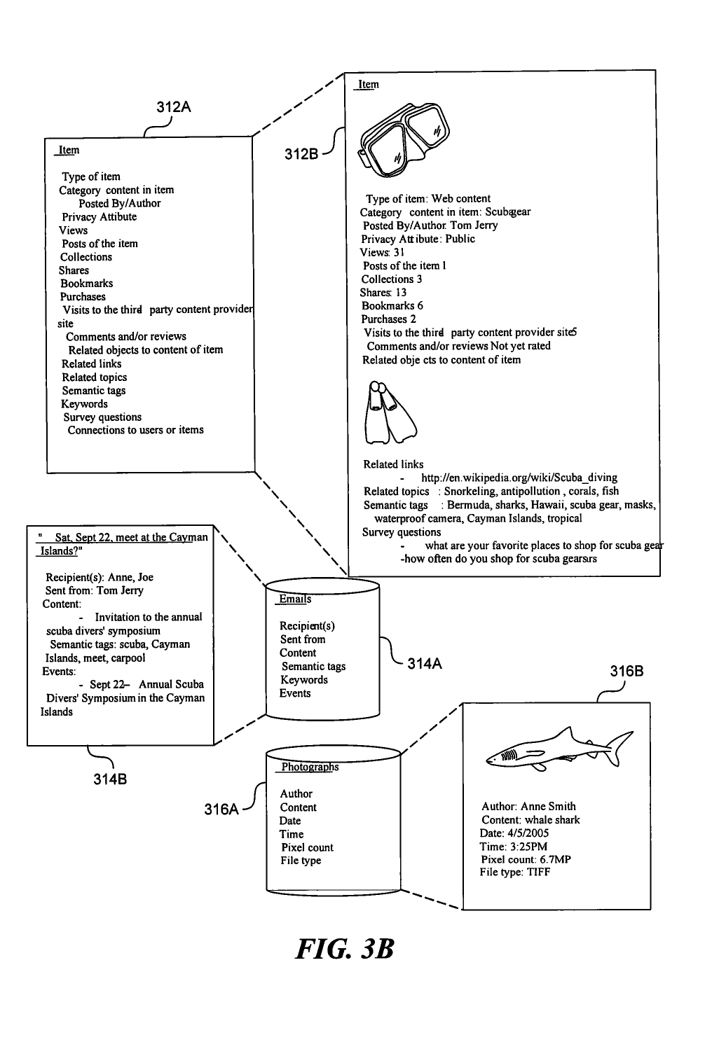

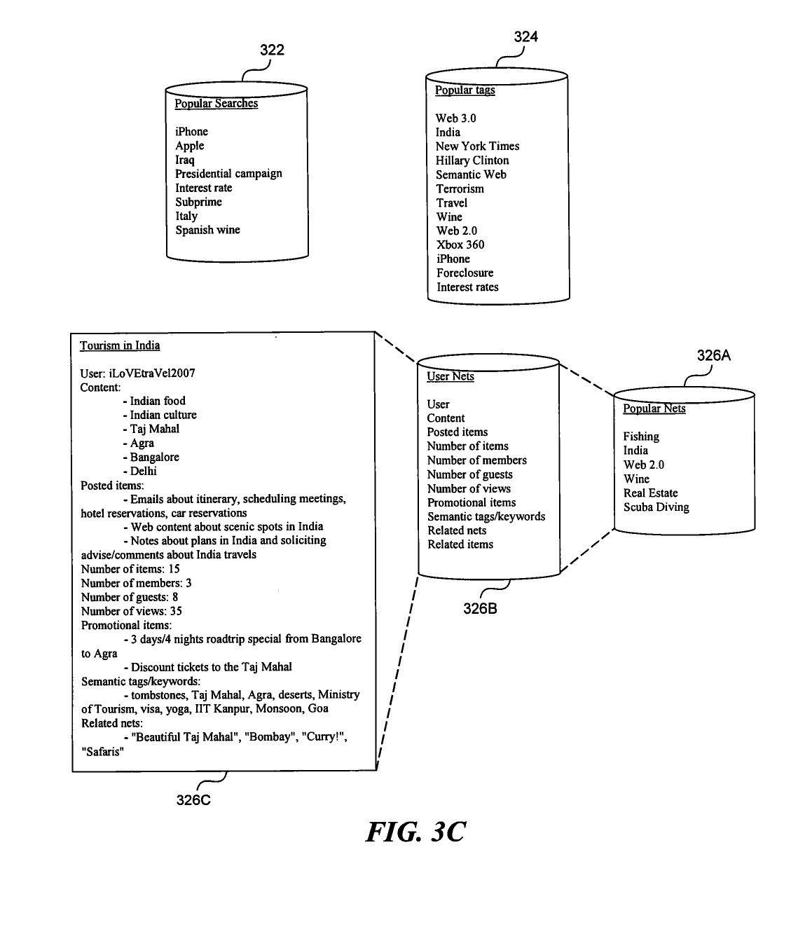

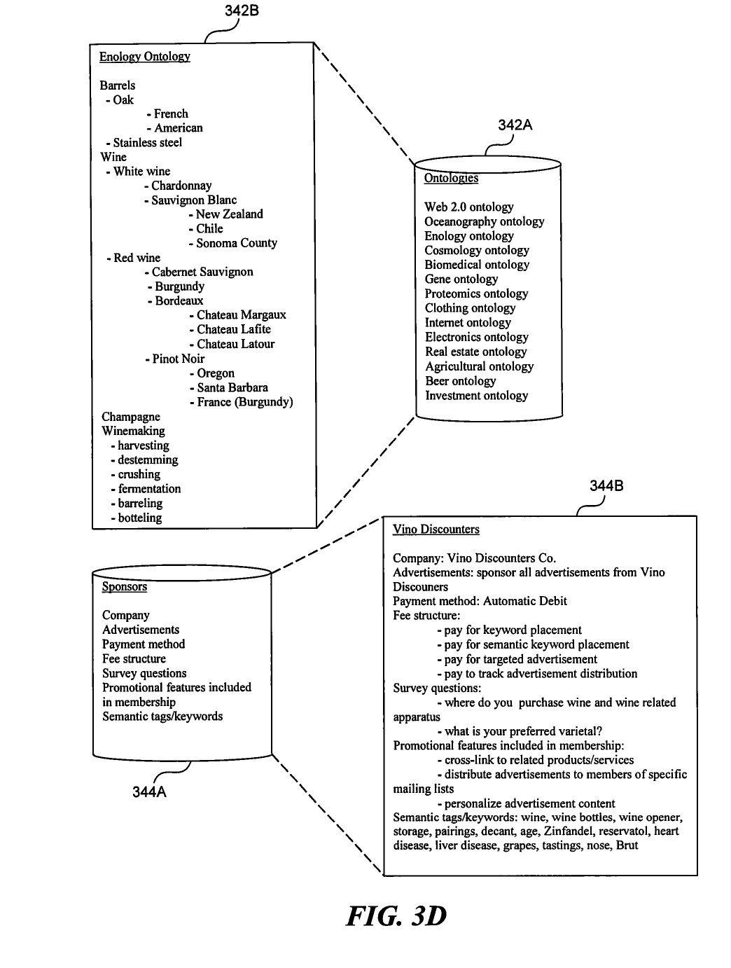

FIG. 3A depicts a block diagram illustrating a database for storing user information of users (visitors and/or service subscribers) 302 and a database for storing user group information 304, according to one embodiment.

In the example of FIG. 3A, the database 302A can store information about users, including visitors and/or service subscribers. For example, the user information stored can include descriptive data of personal information such as, but is not limited to, a first name and last name of the user, a valid email ID, a unique user name, age, marital status, occupation, location, education, home town, schools attended, number of siblings, heritage, ethnicity, race, etc. The user information further includes interest information, which may include, but is not limited to, activities, hobbies, professional information, photos, etc.

The database also stores web content (e.g., third-party) provided by the user, for example, the web content themselves can be stored, the types of web contents (e.g., email, vcf card, calendar events, web content, web links, etc.), tags in the web content, nets that the user belongs to, information of contacts, connections to other users and/or items, etc. In one embodiment, a user creates one or more nets with varying themes to which objects (e.g., web content) can be added. The user can also join nets created by other users and access items in the nets of the other users, while conforming to the access rights specified by the other users and specific for the nets. Further, in addition to storing information of contacts in the database, the user is able to connect to other users (e.g., visitors and/or service subscribers) and specify a designated relationship to the other users. The user's connections and the relationships of the connections (e.g., friends, relatives, and co-workers) are, in some embodiments, stored in the database.

In one embodiment, user information stored in the database is explicitly specified by the user. For example, when the user (e.g., visitor/service subscriber) signs up for access to the networking environment, a set of information may be required, such as a valid email address, a username, and/or age. A user information form can include optional entries, by way of example but not limitation, location, activity, hobbies, ethnicity, photos, etc. In one embodiment, user information is identified from web content the user added to the networking environment. For example, the networking environment can automatically determine user interests and/or hobbies based on the identified intellectual content of the web objects provided by the user. Hobbies and interest can also be determined by, for example, but are not limited to, the events that a user attends and/or common interests of a user's contacts.

Each entry or a category of entries (e.g., subscription information, personal information, interest information, etc.) related to user information in the database 302A can have permission settings regarding visibility and accessibility to other users. The privacy settings may, in some embodiments, vary between registered and non-registered users (visitors), contacts with different relationships with the user (e.g., a friend, colleague, family, etc.). In addition, the privacy settings may be different and individually specifiable for each contact of a user.

An example of the user information for the user “Tom Jerry” that is stored in database 302A is shown in 302B. The user “Tom Jerry” has an email address of “TomJerry@radarnetworks.com”, an age of “25”, is located in “Bermudas” and is “Bermudan” by ethnicity. The user “Tom Jerry” is recorded to have an education level of “BS, MBA”, and likes to engage in activities related to “Scuba Diving, outdoors activities”. Specifically, “Tom Jerry” is also interested in “Fishing”. The items that “Tom Jerry” has provided include web content, photographs, and emails.

The database 302A also records information about the content of the items, for example, the items provided by “Tom Jerry” includes “blogs on fishing” and “advertisements for wetsuits/regulators”, and “websites of online retailers selling scuba diving gear”; recent content includes http://www.scuba.com and “emails from Joe”; personal nets include “Snorkeling in the Bermudas”. The tags of Tom Jerry's web content include “Hawaii”, “Scuba masks”, and “Sharks”. “Tom Jerry” has also specified the privacy settings such that the contents of Tom Jerry's web objects and/or user information are “visible to contacts only”. Tom Jerry's contacts include “Anne Smith” and “Joe Shmoe”; he belongs to the nets “World Peace” and “Snorkel Club”; he is also connected to another user's item, for example “Joe's web link to a snorkel vest”.

With further reference to FIG. 3A, database 304A includes data related to information of user groups formed in the networking environment. A user can form a group, where invitees are invited to join the group. Alternatively, one or more users can create a group, for example, based on a common theme or interest. In other examples, groups may be formed as a channel for sharing information with a focused group of users within the networking environment, with or with out common interest. Group data in the database 304A, includes, for example, shared interests represented by the group. The database, in addition, stores information about the privacy attributes of the group, which can indicate group membership criteria, access to information posted in the group between group members and visitors, for example. Certain content and/or information may only be visible and/or accessible to a subset of members of the group. In addition, items posted on the group net may not be visible to users that are not members of the group. The database further stores membership information regarding the members of the group, membership requests, and/or items that are shared between group members.

An example of group information stored in the database 304A is shown in 304B for “the Under-water Club”. The group interests include “diving”, “snorkeling”, and the “Peace Corps”. The privacy attributes of “The Under-water Club” are “invite only”, which indicates that a user can only join the group when a membership request is approved. Current members of “The Under-water club” include “Tom Jerry” and “Anne Smith”; a membership request is currently active for user “Joe Shmoe”. The shared items between the members of “The Under-water Club” include “Underwater Photography” and “Online retailers for underwater gear”.

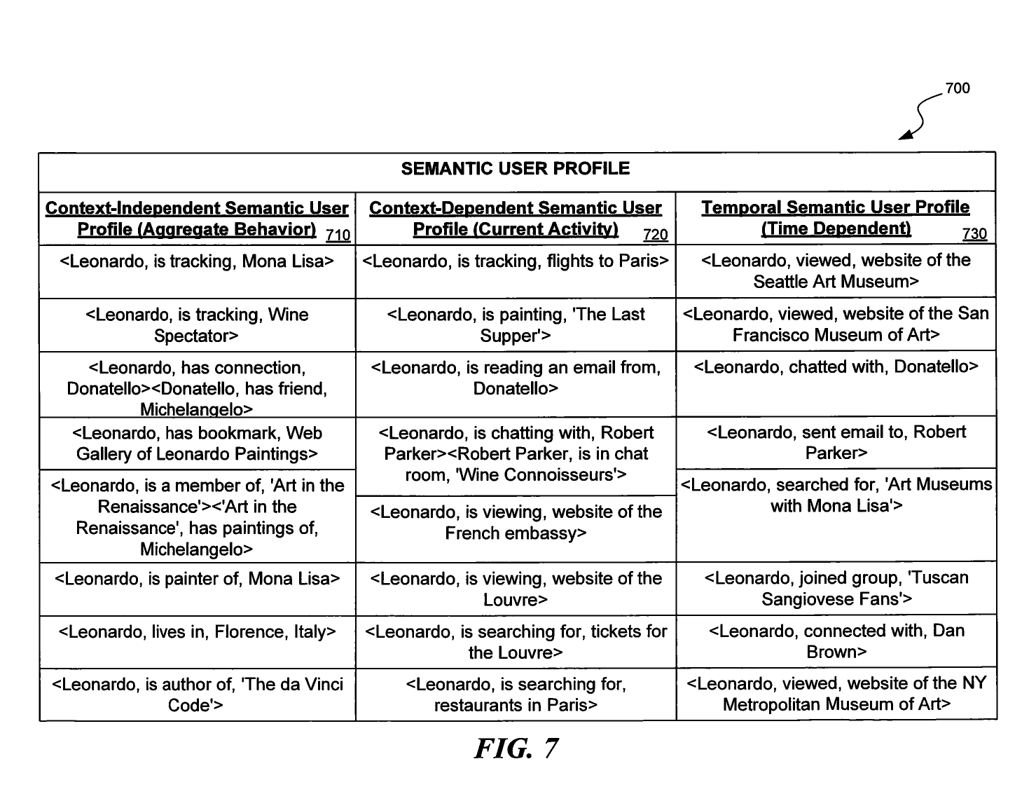

In one embodiment, the user database 302A also stores semantic user profiles. Semantic user profiles are illustrated with further reference to the example tables of FIG. 7.

FIG. 3B depicts a block diagram of a database for storing items 312A, a database for storing emails 314A, and a database for storing photographs 316A, according to one embodiment.

The database 312A can store data regarding information of items (referred to herein after as “item data”) provided by users. The items are, in some instances, web objects, such as, web content, emails, photography, emails, calendar events, contact information, etc. Item data stored in the database can also include information about the item type, the subject matter of the content provided in the item (e.g., whether the web content contains information regarding fishing, the presidential election, etc.), and/or who added the item to the networking environment (e.g., the user that posted the item, or the user that authored the item). Item data can also include information regarding the privacy attributes associated with the item. For example, if the item can be viewed publicly, if the item can only be viewed by registered users, if the item is blocked from particular users, if the item is public to users that belong to certain user groups, if the item is available upon request on an individual or subgroup basis, etc.

Item data may further include the number of views of the item. For example, the number of views can be stored as the total number of views since the item has been posted, the number of views for a predetermined amount of time (e.g., a day, an hour, last 12 hours, etc.), the total number of views from users that belong to a particular user group, from users having a particular interest, are some ways that popularity of an item can be determined. In some embodiments, the same item may be posted on the networking environment by different users, thus, the database can include item data to indicate how many users have posted the same item.

In addition, item data regarding the number of collections of an item can be stored in the database 312A. For example, once an item has been visited, a user may wish to add an item of interest to a net in the networking platform for future access. Similarly, a user may bookmark (e.g., add the link to the item as a bookmark in the web browser) an item for future access as an alternative to collecting the item. A user may also wish to share an item (e.g., that either the user posted on the networking environment or collected from another user) with a third user. In one embodiment, item data indicative of item popularity, including but not limited to, collection data, bookmarking data, and sharing data, data indicating shares with other nets, is stored in the database 312A.

Additional item data that may be indicative of item popularity include data of visits to the third-party web site hosting the web content provided by the item, transactions (e.g., purchases, sales, rents, leases, bids, etc.) that occurred due to viewing of the object via the networking environment, comments and/or reviews related to the web content provided by the object, for example. In one embodiment, item data stored in the database 312A include keywords identified from the content of the web object.

In some embodiments, item data include semantic tags identified from the web content, tagged by the system, tagged by the user that provided the web content, tagged by the third party content provider and/or tagged by the sponsor. Thus, in addition, content/items related to the web content, web links containing information related to the contents of the object, additional content including topics similar to content provided by the object can also be identified (e.g., based on a keyword match and/or a semantic match) and stored in the database 312A.

In one embodiment, survey questions can be presented to a user that demonstrated interest in the item. For example, interest can be indicated when the user clicks on a link to the item, when the user submits the item to the networking environment, when a user bookmarks the item, when a user shares the item, when a user collects the item, etc. The survey questions may be a predetermined default set of questions or the survey questions may be provided by the third-party that provided the web content. Thus, the survey questions associated with an item are stored in the database 312A, in one embodiment. The database 312A can further store data indicating the triggers that cause a particular survey question to be presented to a user. For example, a first set of questions can be presented to a user when the user adds the item to the networking environment, whereas a second set of questions are presented to a user when the user shares an item with another user on the networking environment.

An example of item data stored in the database 312A is shown in 312B. The type of the item is “web content” and content of the item belongs to the category of “Scuba gear”. The item is posted by/authored by “Tom Jerry” and its privacy attribute is “Public”. The item has had “31” views, “1” post, “3” collections, “13” shares, “6” bookmarks, and “2” purchases via the networking environment. The number of visits to the third-party content provider site from a viewing of the item on the networking environment is “5”. The item status for comments and/or review is “Not yet rated”.

An object that is related to the content of the item is stored on the database as an image of a pair of flippers. A related link to the content of the item is http://en.wikipedia.org/wiki/Scuba_diving. The related topics to item content include “Snorkeling”, “antipollution”, “corals”, and “fish”. The semantic tags related to the item include, “Bermuda”, “sharks”, “Hawaii”, “scuba gear”, “masks”, “waterproof camera”, “Cayman Islands”, and “tropical”. The survey questions associated with the item are “what are your favorite places to shop for scuba gear?” and “how often do you shop for scuba gear?”

The database 314A in the example of FIG. 3B stores the emails and data/information associated with the emails (referred to herein after as ‘email data’) added by the users to the networking environment. Examples of email data that are stored include but are not limited to the recipient(s) of the email, whom the email is sent from, the content of the email, the semantic tags associated with the email, the keywords identified from the text body of the email, and/or scheduled events identifiable via the body of the email.

An example of email data stored in the database 314A is shown in 314B. The title of subject line of the email is “Sat. September 22, meet at the Cayman Islands?” The recipients of the email are “Anne” and “Joe”, the email is sent from “Tom Jerry. The identified content of the email is an “Invitation to the annual scuba divers' symposium”. The semantic tags identified from the email, either tagged by a user, specified by the content provider, or automatically identified by the networking environment, are “scuba”, “Cayman Islands”, “meet”, and “carpool”. The identified event to be scheduled in this email is “September 22—Annual Scuba Divers' Symposium in the Cayman Islands”.

The database 316A in the example of FIG. 3B stores the photographs and data/information associated with the photographs (referred to herein after as ‘photograph data’) provided by the users to the networking environment. Examples of photograph data that are stored include but are not limited to the author of the photograph, the content of the photograph, the day/time the photograph was taken, saved, edited, and/or otherwise modified. The pixel count and file type of the photograph. An example of photograph data stored in the database 316A is shown in 316B. The author of the photograph is “Anne Smith”, and the contents of the photograph include the “whale shark”. The photograph was taken at “3:25 PM on 4/5/2005”; the pixel count of the photograph is “6.7 MP” and the file type is “.TIFF”.

FIG. 3C depicts a block diagram of a database for storing popular searches 322, a database for storing popular tags 324, a database for storing popular nets 326A, and a database for storing nets 326B, (e.g., user nets) according to one embodiment.

The database 322 stores a list of popular searches that occurred on the networking environment. The popular searches can be determined based on the total number of searches that occurred for the keyword over a predetermined amount of time. Similarly, the popular searches can be determined based on the rate of increase in the number of searches for a particular keyword over a predetermined amount of time. In some embodiments, the searches for the same keyword that originate from the same user, IP address, or machine ID, for example, are factored in and not counted towards the tally towards determining popularity of a search term. In the example database 322 of FIG. 3C, the identified popular searches include the keywords “iPhone”, “Apple”, “Iraq”, “Presidential campaign”, “Interest rate”, “Subprime”, “Italy”, and “Spanish Wine”.

The database 324 stores a list of popular tags on the networking environment. The tags can, in some embodiments, be identified from items (e.g., web content, email, web objects, photographs, contacts, calendar events, etc.) provided by users in the networking environment. For example, an item can be tagged with keywords added by a user to the networking environment and/or be tagged automatically by the system based on a set of metadata/meta-tags associated with the item. In addition, the item may be tagged by the third-party provider of the item. In some embodiments, the meta-tags include semantic tags. Thus, items having topically similar and/or related content can be identified in the networking environment items database and counted towards identifying the popular tags.

Additionally, tags indicating similar and/or related keywords and tags can be identified in user information databases in determining the popular tags on the networking environment. Additional methods and/or algorithms for identifying popular tags are contemplated and expected and do not deviate from the novel art of this disclosure. In the example database 324 of FIG. 3C, the identified popular tags include “Web 3.0”, “India”, “New York Times”, “Hillary Clinton”, “Semantic Web”, “Terrorism”, “Travel”, “Wine”, “Web 2.0”, “Xbox 360”, “iPhone”, “Foreclosure”, and “Interest rates”.

The database 326A stores a list of popular nets on the networking environment. In the example database 326A of FIG. 3C, the identified popular nets stored in database 326A include “Fishing”, “India”,“Web 2.0”, “Wine”, “Real Estate”, and “Scuba Diving”. In one embodiment, each net that is identified as popular in the database 326A is an individual net and determined as ‘popular’ based on the number of members in the net. Alternatively, the popularity can be determined by the total number of views of the net over a predetermined amount of time, regardless of whether the net was viewed by a registered user or a visitor. The popularity can also be determined by the rate of increase of views over a predetermined amount of time. In some embodiments, the popularity is determined by the total number of views of the net generated by users who are not members of the net.

In some embodiments, the views generated by the same user in a net do not count towards the number of views that determine popularity of a net. In one embodiment, each identified popular net includes a plurality of nets that relate to a similar topic. For example, the popular net “India” may include the nets having topics similar to but is not limited to the “Taj Mahal”, “tombstones”, “Bangalore”, “Bombay”, “authentic curry”, etc. Since in some embodiments, the contents of the nets have semantic meta-tags, other related content (e.g., similar and/or related content on other nets) shared on the networking environment are identified and a set of popular nets having similar and/or related content can be determined.

The database 326B stores the user nets and data/information associated with the user nets (hereinafter referred to as ‘user net data’). The user net data stored in the database 326B can include, for example, but is not limited to, the user(s) who created the net, the contents of the net, items posted in the net, the number of items posted in the net, the number of members in the net, the number of guest visitors in the net, the number of views, promotional items, semantic tags and/or keywords, related nets, and/or related items.

One or more users can create a net, for example, to facilitate information/knowledge sharing and/or to provide centralized access to a set of data/information. In addition, since in some embodiments, semantic meta-data tagging enables similar and/or related data/information to be identified on the networking environment, nets can be created by a user to add information and to identify additional related information provided by other users through items added by the other users and/or the nets created by the other users. The additional items and nets of other users can be stored in the database 326B such that when the net is accessed by a user, the user is apprised of related or similar items and nets that may be of interest to the user. The items in a net may or may not have a common theme or topic of interest. Thus, the identified contents of the net, either based on keyword matches, semantic matches, as identified automatically, by the user, and/or by the third party content provider, can be stored in the database 326B. In one embodiment, a list of promotion items provided in the net is stored in the database 326B. A promotional item can be a third party advertisement or other types of endorsements for a product and/or service added to the net by a user or members of the net.

An example of user net data stored in the database 326B is shown in 326C. The user that created the net “Tourism in India” has a user name of “iLoVEtraVel2007”, and the contents of the net include “Indian food”, “Indian culture”, “Taj Mahal”, “Agra”, “Bangalore”, and “Delhi”. The items posted on the net include “Emails about itinerary”, “scheduled meetings”, “hotel reservations”, and “car reservations”, “web content about scenic spots in India”, and “Notes about plans in India and soliciting advise/comments about India Travels”.

The number of items posted in the net is ‘15’, the number of members of the net is ‘3’, the number of guests to the net is ‘8’, and the number of views of the net is ‘35’. The promotional items in the net include “3 days/4 nights road trip special from Bangalore to Agra”, and “Discount tickets to the Taj Mahal”. The semantic tags/keywords determined in the items included in the net include “tombstones”, “Taj Mahal”, “Agra”, “deserts”, Ministry of Tourism”, “visa”, “yoga”, “IIT Kanpur”, “Monsoon”, and “Goa”. Nets related to “Tourism in India” include “Beautiful Taj Mahal”, “Bombay”, “Curry!”, and “Safaris”.

FIG. 3D depicts a block diagram of a database for storing ontologies 342A and a database for storing sponsorship or advertiser information 344A, according to one embodiment.

The database 342A stores the ontologies available in the networking environment. The ontologies can be provided and integrated by administrators of the networking environment. In addition, ontologies can be requested by a user to be added into the platform, or added to the platform by a user. In the example database 342A of FIG. 3D, the currently available ontologies include the ontologies for “Web 2.0”, “Oceanography”, “Enology”, “cosmology”, “Biomedical Ontology”, “Proteomics”, “Clothing”, “Internet”, “Electronics”, “Real estate”, “Agricultural”, “Beer”, and “Investment”. An example of a portion of the enology ontology stored in the database 342A is shown in 342B. The enology ontology includes a list of the different types of barrels (“Oak” (e.g., French oak and American oak), “Stainless Steel”, different types of wines (“White wine (e.g., Chardonnay and Sauvignon Blanc), “Red wine” (e.g., Cabernet Sauvignon, Burgundy, Bordeaux, and Pinot Noir), “Champagne”), and the different steps involved in wine making (“harvesting”, “de-stemming”, “crushing”, “fermentation”, “barreling”, and “bottling”).

The database 344A stores a listing of sponsors and data/information associated with the sponsors (referred to hereinafter as ‘sponsor data’ or ‘advertiser data’). A sponsor can be an enterprise subscriber, an advertiser, or any entity/organization that wishes to utilize the knowledge networking platform for enhanced targeted advertising.

As discussed, the web content added by users to the networking environment can sometimes include promotional content (or, advertisement) that promotes one or more of an idea, product, and/or service. Similarly, the content provider can be a service subscriber of the knowledge networking environment services and shares items having promotional content/advertisements on the network to increase exposure and access of the promotional content to users of the networking environment.

In some embodiments, the content provider can become a sponsor, such that when web content provided by the content provider is added to the networking environment (e.g., either by the third-party content provider and/or another user), the content provider can have access to additional services, in particular, marketing services and access to market-related data relevant to the ideal/product/service the content provider wishes to promote. In some instances, the sponsor is not necessarily the content provider of the web content but merely an entity with vested interest in the promotional material in the web content. In some situations, membership fees may be assessed in association with sponsorship of promotional content/advertisements in the knowledge networking environment.

The sponsor data stored in the database can include but is not limited to, the sponsoring organization, the advertisements that are being sponsored by the organization, the payment method, the fee structure adopted by the sponsor, the survey questions the sponsor wishes to be presented to users, the promotional features included in the membership, and the semantic tags/keywords related to the sponsorship, business, trade, service and/or product.

An example of a portion of the sponsorship data stored in the database 344A is shown in 344B. The sponsor “Vino Discounters” sponsors “all advertisements from Vino Discounters” on behalf of the company “Vino Discounters Co.”. The sponsor has signed up for the additional services to “pay for keyword placement”, “pay for semantic keyword placement”, “pay for targeted advertisement”, and “pay for track advertisement distribution” and the payments are to be remitted via “Automatic debit”.

The survey questions to be presented to a user whom has indicated interest in a sponsored advertisement include “where do you purchase wine and wine related apparatus”. The promotional features included in the sponsorship of “Vino Discounters” include “cross-link to related products/services”, “distribute advertisements to members of specific mailing lists”, and “personalize advertisement content”. The semantic tags/keywords associated with content provided by the sponsor include “wine”, “wine bottles”, “wine opener”, “storage”, “pairings”, “decant”, “age”, “Zinfandel”, “reservatol”, “heart disease”, “liver disease”, “grapes”, “tastings”, “nose”, and “Brut”.

In one embodiment, the database 344A stores model profiles. Model profiles may be specified by the particular sponsor or advertiser. Generally, model profiles depict the characteristics of an ideal user to whom the advertisement is to be targeted.

In some instances, model profiles are created with the assistance of the knowledge networking platform or other marketing entities unaffiliated with the sponsor/advertiser. For example, external marketing firms can be retained to perform the necessary research to construct a model profile. In addition, the networking platform provides assistance to the advertiser in creating a model profile utilizing the wealth of information related to users. This information can be collected based on user activity, user habits, user behavior, user profile, and/or user preferences in the knowledge networking environment to provide insights to user interests and preferences to assist a sponsor/advertiser in creating a model profile.

Once the model profile has been constructed, the knowledge networking platform, in one embodiment, parses the data and searches the user database (e.g., the user database of FIG. 3A) for user profiles similar or correlates to the model profile.

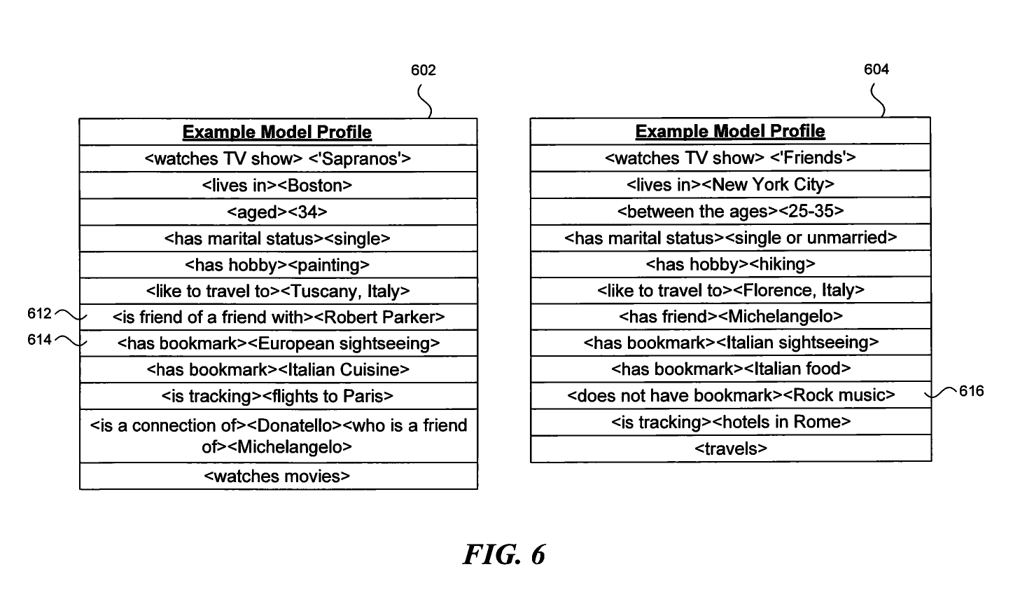

Example model profiles are described with further reference to the example of FIG. 6.

More or less databases may be included. The databases can store other types of information, including but not limited to, information, data, services pertaining to knowledge/information sharing, and user friendliness, and/or additional information related to tracking and monitoring propagation of web content and information among the users in the networking environment. Additional data types that can be stored in databases, such as data related to delivering the services, functions, and features of a web-based networking environment to providing advanced marketing services to entities utilizing the knowledge networking to intelligently promote an idea/service/product, are contemplated and expected, and do not deviate from the novel art of this disclosure.

In some embodiments, one or more databases can be implemented as one database and different types of information can be stored in combination rather than in separation as shown in the example databases of FIG. 3A-3D.

FIG. 4A illustrates a diagrammatic representation of an example semantic graph 400 compiled from user activity in the networking environment showing neighboring entities having a relationship of one degree and two degrees of separation 410 and two degrees of separation 420 with a central entity 402, according to one embodiment.

The central entity 402 illustrated in the example of FIG. 4A is a religious user named “Grace”. The central entity 402 of a semantic graph can generally be selected as any entity in the knowledge network. In a non-limiting example, the central entity may be another user, a physical entity, or an organization. The semantic graph 400 can be constructed to assist in the determination of proximity distance between the central entity (user “Grace”) 402 and related entities. For example, user “Grace” 402 is a member of the Buddhist Religion Net. The user “Grace” 402 also has the contact “Dalai Lama”, is a member of the “Christian Religion Net”, and the “Muslim Religion Net”.

By identifying the entities that have a relationship with one degree separation with the central entity “Grace” 402, entities of a second degree relationship 420 with the central entity 402 can thus be identified. For example, the “Buddhist” Religion Net has the link “Buddhist Temple Web Page”. The “Dalai Lama Contact” is the author of the “Buddhist Temple Webpage”. The “Christian Religion Net” has a picture of the “Christian Church”. Similarly, entities having third, fourth, fifth, . . . N-th degree relationships with the central entity 402 can further be identified.

The semantic graph serves as a mechanism to visualize how proximity between the central entity 402 can be computed for target entities of varying degrees of separation. For example, to determine the proximity between the central entity “Grace” 402 and the entity “Buddhist Temple Web Page” 404, the paths through which the entity 404 can be linked to the central entity 402 are identified. In the example of FIG. 4A, the “Buddhist Temple Web Page” entity 404 can be linked to the central entity 402 via pathways 412 or 414. The pathway 412 includes a combination of the relationship “has contact” 412A and the relationship “author of” 412B. The pathway 414 includes a combination of the relationship “is member of” 414A and the relationship “has link” 414B.

The proximal distance between the central entity 402 and the entity 404 is thus the product of the probability that the user will reach entity 404 via the pathway 412 and the probability that the user will reach entity 404 via pathway 414.

The processes for probability assignment and proximity computation is illustrated with further reference to the example of FIG. 4B.

FIG. 4B illustrates a diagrammatic representation of an example semantic graph 450 showing relative probabilities that correspond to the likelihood that a user associated with an entity will browse to a neighboring entity, according to one embodiment.

The semantic graph 450 can facilitate proximity distance computation for the central entity 452. In this example, the central entity 452 has three related entities with one degree of separation, eight related entities with two degrees of separation, and one related entity with three degrees of separation. To determine the proximity between the central entity 452 and the target entity 454, the probability of each pathway that a user associated with the central entity 452 can be linked to target entity 454 is considered. The pathways are determined by relationship between entities and their presence is illustrated by lines connecting the related entities.

In particular, the proximity between the central entity 452 and the target entity 454 is the product of the probability of pathway A 456, pathway B 458, and pathway C 460. The probability associated with pathway A 456 is the product of the probabilities p1A, p2A, and p3A. The probabilities p1A, p1B, p1C, p2A, p2B, p2C . . . etc. are, in one embodiment, determined based on the types of relationships between the associated neighboring entities. For example, the central entity 452 is related to three entities with one degree of separation. The probabilities that the user associated with the central entity 452 will browse to each of the three entities are represented by p1A, p1B, and p1C, respectively. The relative weight between p1A, p1B, and p1C at least partially depends on the type of semantic relationship between the central entity 452 and each of the three neighboring entities. In some embodiments, the relative weights between p1A, p1B, and p1C are user-defined and may be adjustable by the system or by the user. Default settings may be available. The relative weight is then normalized to obtain absolute probabilities such that the sum of p1A, p1B, and p1C add up to approximately one.

In one embodiment, the probabilities of the links decay with increased degrees of separation from any given entity. For example, the relative weight between links p1A, p2A, and p3A decrease linearly according to the number of degrees of separation. Alternatively, the relative weights between links p1A, p2A, and p3A decrease exponentially and can be characterized by a probability distribution (e.g., the power-law).

Accordingly, probabilities p2A, p2B, p2C, p3A, p3B, and p3C can be similarly obtained. Therefore, the aggregate proximity between the central entity 452 and the target entity 454 is thus p1A+p2A+p3A+p1B+p2B+p3B+p1C+p2C+p3C.

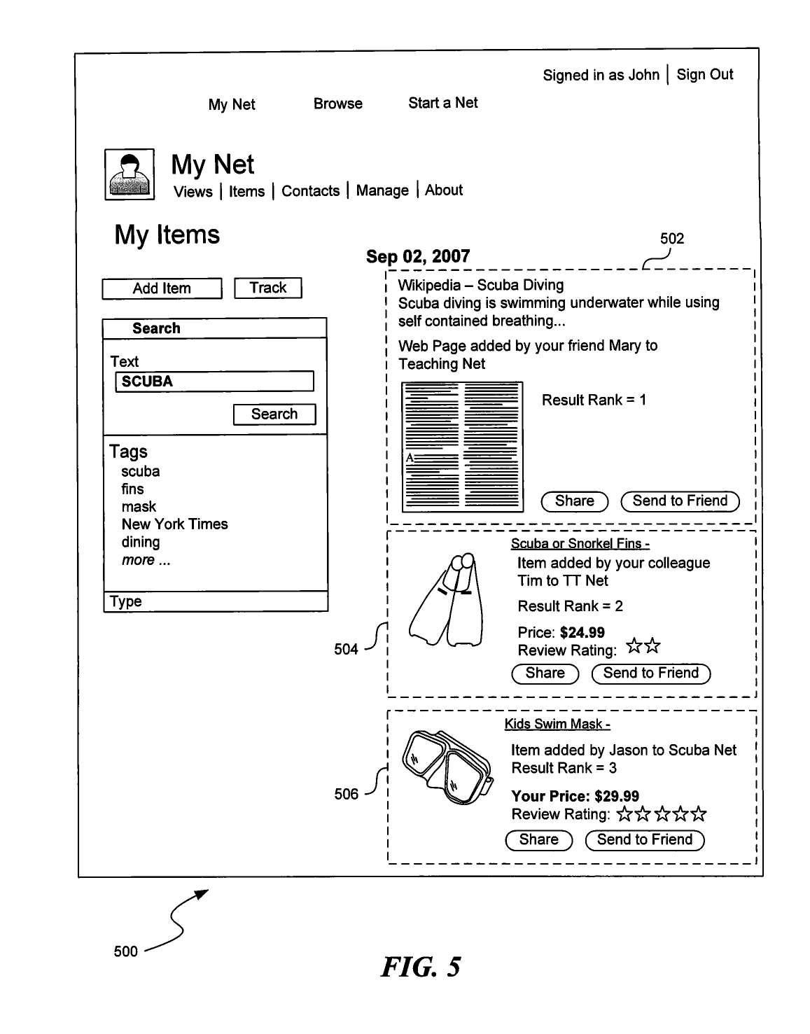

FIG. 5 illustrates an example screenshot 500 of a graphical user interface displaying search results that are ranked based on proximity to the user, according to one embodiment.

In the example of FIG. 5, search result 502 is ranked #1, search result 504 is ranked #2, and search result 506 is ranked #3. The search results 502, 504, and 506 are presented in response to the search query “SCUBA”. In a socially-enabled knowledge networking environment where social proximity between users and other entities can be determined, search results for keyword-based or semantics-based search queries can be optionally ranked as a function of proximity (e.g., distance of social links and/or semantic links).

In this instance, the web page that was added by a friend of the user was ranked higher than an item added by a colleague of the user. The item added by the colleague was ranked higher than the item added by user “Jason”. Of course, the weight to assigned to proximity version keyword and/or semantic relevancy can be adjustable based on user preferences or system settings.

FIG. 6 depicts tables illustrating examples of model profiles 602 and 604, according to one embodiment.

Model profiles 602/604 can be created and provided by advertisers (e.g., sponsors, content providers) as a representation of the ideal characteristics of a user towards whom a particular advertisement or promotional content is to be targeted. The advertisers may specify the set of desired qualities in the form of semantic relationships. Each characteristic, in one embodiment, takes the form of <model user><relationship><referenced entity> (e.g., in any semantic web triple format including but not limited to: <subject><predicate><object>). The model profile can then be parsed to obtain a set of model user metadata associated with the ideal user characteristics.

The model profiles 602 and 604 can be converted to semantic graphs such as the semantic graphs of FIG. 4A-B. Each referenced entity would be nodes on concentric circles surrounding the central entity (e.g., the model user). The distance of the concentric circle from the central entity on which each referenced entity exists depends on the number of degrees of separation the referenced entity is from the central entity. The example model user profile 602 includes entry 614 where the model user <has bookmark> <European sightseeing>. The referenced entity of a website for <European sightseeing> would be represented as a node on the concentric circle closest to the central entity. In entry 612 of the model profile 602, the model user <is friend of a friend with> <Robert Parker>. In this instance, the referenced person <Robert Parker> would be represented as a node on the second concentric circle from the central entity.

The semantic graphing of the model profiles such as profile 602 and 604 allow proximity distances between the model user and the specified entities of predetermined types of relationships to be compared with the proximity distances between any given user and the various related entities in the networking environment. The specified entities of the model profile (e.g., referenced entities) and the entities in a user profile can be compared to determine the level of correlation in characteristics between the model user and any given user in the networking environment. In particular, the model user metadata can be compared with the user metadata of the user's semantic profile to determine the level of correlation. In one embodiment, a correlation index is generated to indicate the degree of correlation between the model profile and the semantic user profile.

Furthermore, proximity distances between the referenced entities of the model user and a given user can be factored into the process of determining the correlation. The correlation can be used, for example, to identify one or more users with characteristics that are similar to the model user specified by the advertiser. In general, the correlation decreases with each degree of separation (e.g., decreased proximity) between the referenced entities of the model user and any given user. Accordingly, the correlation increases with lesser degrees of separation (e.g., increased proximity). This service and information can be provided to the advertiser such that the knowledge networking environment may be leveraged for more enhanced advertisement targeting by identifying a pool of candidates through consideration of proximity distances.

The advertiser may specify the desired degree of correlation between the model profile and any given user. For example, the advertiser can specify that they wish to present the advertisement or other types of promotional content to users having correlation to the model profile that exceeds a particular threshold value. A default threshold for the correlation may exist depending on a number of variables, such as, size of dataset, type of advertisement, etc. The advertiser may also specify a predetermined number of users having the highest correlation be identified. A fee can be assessed from the advertiser for providing such services.

An example user profile is illustrated with further reference to FIG. 7.

FIG. 7 depicts tables illustrating an example of a semantic user profile built from examples of context-independent 710, context-dependent 720, and temporal semantic user profiles 730, according to one embodiment.

A semantic user profile 700 can be generated from semantic information collected about a user under various contexts. For example, information collected from different time periods may be weighted differently in generating the semantic user profile 700.

In one embodiment, user information is categorized as, the context-independent semantic user profile 710, the context-dependent semantic user profile 720, and/or the temporal semantic user profile 730. The semantic user profile 700 is usually generated from at least one of the above three contextual types of semantic user profiles.

In generating the semantic user profile 700, relative weight can be assigned to each of the various contextual types of semantic user profiles. The weighing factors assigned to each type of profile can be predetermined, determined on demand, or adaptive. The weighing factor may be application dependent, specified by the end-user, or specified by the advertiser.

In general, the context-independent user semantic user profile 710 includes context-independent metadata related to aggregate behavior of a user on the network. Aggregate behavior generally describes historical information collected about a user. For example, attributes of a user such as place of residence, hobbies, activities, occupation can be considered aggregate and context-independent. Furthermore, user behavior in the network that appear to be habitual including, by way of example but not limitation include, ranking items, adding friends, adding items, sharing items, etc. can also be considered context-independent.

The context-dependent user semantic user profile 720 includes context-dependent metadata related to a user's current activity and behavior in the knowledge network. For example, current activity can include the webpage the user is currently viewing, an email that the user is currently reading or responding to, a message that a user is currently reading, a search being generated by the user, etc. Current activity of a user can be compiled for a predetermined amount of time through, for example, recording click stream history. In general, click stream history includes the notion of analyzing the data be accessed to determined the content. Additionally, click stream history also includes information related to identifiers of an external source for content in the knowledge network.

In addition to tracking click stream history, current activity can be determined by detecting and analyzing client side activity (e.g., mouse activity) and cross referencing external third-party entities to extract information related to user interests/preferences.

The temporal semantic user profile 730 includes temporal metadata related to user activity that recently occurred in the networking environment. For example, recent activity can include user activity/behavior that occurred over a predetermined amount of time (e.g., 5 days, a week, two weeks, a month, etc.). For example, recent activity can include information such as, website that were visited in the last week, with whom the user has chatted or to whom messages were sent in the last month, keyword queries submitted in the last three days, etc.

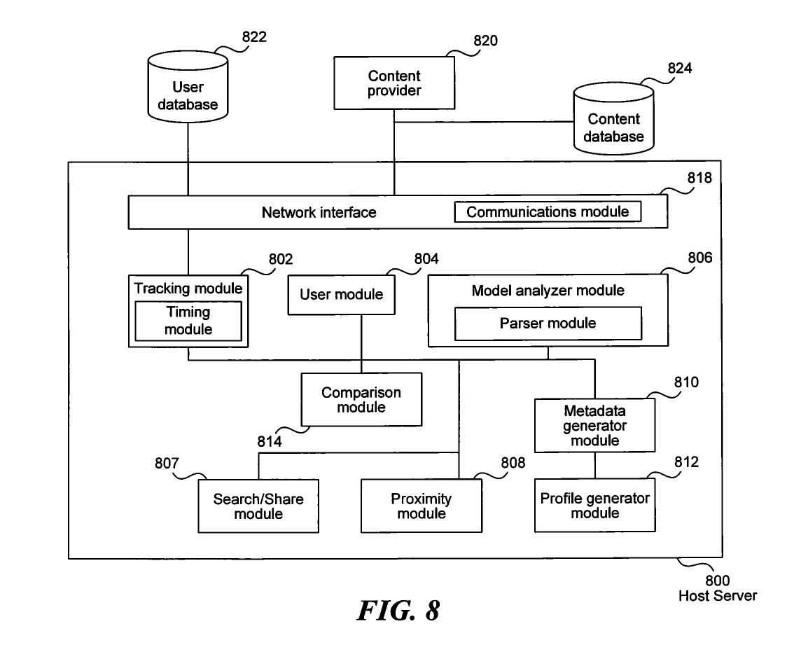

FIG. 8 depicts a block diagram illustrating a system for leveraging proximity data in a web-based socially-enabled knowledge networking environment, the system includes a host server 800 coupled to a user database 833, content provider 820, and/or a content database 824, according to one embodiment.

The host server 800 includes a tracking module 802, a user module 804, a model analyzer module 806 having a parser module, a proximity module 808, a metadata generator module 810, a comparison module 814 and/or a profile generator module 812. Additional or less modules can be included without deviating from the novel art of this disclosure. In addition, each module in the example of FIG. 8 can include any number and combination of sub-modules, and systems, implemented with any combination of hardware and/or software modules.

The host server 800, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

The tracking module 802 can be any combination of software agents and/or hardware modules able to track user activity related to web content added to the networking environment (e.g., knowledge networking environment). For example, the tracking module 802 records the instances when web content added to the networking environment is viewed, who viewed the web content, and the time and date the content is viewed. The data can be stored in the system for a predetermined amount of time, as suitable. The tracking module 802 may also record the instances when the web content is bookmarked, collected, shared with another user and/or net, and who bookmarks, collects, and/or shares the content. The recipient user and the net receiving the web content can also be recorded. In some instances, the tracking module also records different users add the same content to the networking environment, since identical web content added by different users can be an indication of interest.

In one embodiment, the tracking module 802 determines when a user views a third-party web page in response to viewing web content in the networking environment. The tracking module 802 can also record when additional actions (e.g., purchase, sale, lease, rent, bid, ask a questions, post a comment, send a message, send an email, etc.) occur in response to viewing web content, in particular, web content having promotional content. In most instances, the identities of the parties involved in the action are recorded. In some embodiments, the tracking module 802 collects numerical data regarding content access/distribution and performs elementary statistical analysis on the data collected.

For example, the tracking module 802 can record the number and percentage of visitors that collected the web content, visitors that collected the web content then shared the web content, visitors who made a purchase based on the web content. The tracking module 802 may also record the average number of subsequent shares per user that has viewed the web content, the average number of visits to the web content before collecting it. In one embodiment, the tracking module 802 determines when a user collects web content, the average number of repeat visits to web content per user prior to collecting the web content. The total number of users that the web content has spread to can be determined by the tracking module 802. In addition, the velocity and/or the acceleration of the spread of the web content can be determined and recorded.

In one embodiment, the tracking module 802 determines the total volume of collections, shares, bookmarks, shares, purchases for web content over a predetermined amount of time. For example, the daily volume of the total number of users that collected an advertisement for the iPhone can be determined and stored. In one embodiment, the tracking module 802 can determine which users are the top spreaders of the web content. In some embodiments, the tracking module 802 distinguishes between a visitor who is not a subscriber and a visitor who is a subscriber and records the subscription status of a user who accessed and/or distributed web content.

The user module 804 can be any combination of software agents and/or hardware modules able to identify user metadata from a set of user information. The user information can be supplied by the user and/or identified by the networking environment. For example, the user information can include basic profile information submitted by the user during registration, such as a first and last name, birth date, location, etc. In addition, the user may have the option of submitting additional information including but is not limited to, nationality, religion, ethnicity, interests, hobbies, occupation, education, etc. as described in detail in FIG. 3A. User information can also be identified based on user activity on the networking environment.

For example, general interest can be identified from common topics or themes in the content added by a user to the networking environment. Similarly, general interest can be determined based on commonalities between the user and the user's contacts and/or connections on the networking environment. In one embodiment, user information can be deduced from visits to other user nets and views of content provided by other users. Additionally, web content collected and/or bookmarked by the user provides additional information about the user. The type of the web content (e.g., a web page, an email, a photograph, etc.) in addition to the intellectual content of the web content (e.g., the subject matter of an online news paper article) can both be utilized to obtain user information.

In some embodiments, the user module 804 communicates or otherwise shares information with the tracking module 802 such that access/distribution data can be associated with user data about the users involved in the access and distribution of web content. For example, demographic, geographic, and/or psychographic analysis can be performed on the data collected in relation to access and distribution of web content, in particular, promotional content. Alternatively, the data identified and stored by the tracking module 802 and the user module 804 can be stored in a common data depository (e.g., on the tracking module, on the user modules, or external to the tracking and user modules) such that data recorded by the tracking and user modules can be retrieved independently or in conjunction, as necessary.

The model analyzer module 806 can be any combination of software agents and/or hardware modules able to receive a model profile for analysis. The model profile may be received from an advertiser, sponsor, corporate user, etc. An example model profile is illustrated with further reference to FIG. 6. Model profiles can be analyzed to identify the model user metadata associated with ideal user characteristics suitable for a particular advertisement or promotional content. For example, the ideal user characteristics may frequently be determined by an advertiser or promoter. Model user metadata can be obtained by parsing the model profile. In one embodiment, the model analyzer module 806 includes a parser module for parsing model profiles.

For example, in parsing the model profile, entities (e.g., referenced entities) in the model user metadata are identified. Further, the types of relationships with the entities can also be identified. In one embodiment, the degrees of separation between the identified entities and between the model user and the identified entities is determined. In one embodiment, the model analyzer module provides information related to relationships and the associated degree of separation to the proximity module 808. The model user's degree of separation with various reference entities affects the proximity. The proximity module 808 computes the proximity between a central entity and a target entity as a function of their degree of separation in the knowledge network. In one embodiment, the information regarding degrees of separation between entities facilitates the generation or adjustment of a correlation index between the model user profile and another semantic profile.

In one embodiment, a set of model user metadata representing non-ideal characteristics of a model user is also identified. An example of a non-ideal characteristic may be <model user><does not have habit ><smoking> or <model user><does not watch><TV>. Thus, when a user is detected as <having the habit> of the referenced entity <smoking>, the correlation index may be adjusted to indicate a decrease in the degree of correlation.

The metadata generator module 810 can be any combination of software agents and/or hardware modules able to identify, track, and/or generate metadata from user information. For example, the metadata generator module 810 analyzes the user profile in the networking environment and identifies metadata. The information in the user module 804 includes user submitted data and implicit data incorporating information such as user behavior, click stream history, etc. In one embodiment, the metadata generator module 810 communicates user metadata to the profile generator module (e.g., semantic profile generator module) 812.

The profile generator module (semantic profile generator module) 812 can be any combination of software agents and/or hardware modules able to receive a set of user metadata and generate a semantic user profile based on user metadata. The user metadata can include entities in the networking environment and the types of relationships between the entities and the associated user. Using this information, semantic user profiles can be generated.

An example of the semantic user profile generated is illustrated with further reference to the example of FIG. 7. The semantic user profile can include one or more of the context-independent semantic user profile, the context-dependent semantic user profile, and the temporal semantic user profile. In some instances, the profile generator generates semantic graphs such as the example semantic graph of FIG. 4A-B that assist in the determination of proximity between entities.

In one embodiment, the profile generator module 812 categorizes user metadata based its relevant time scale to obtain the different types of semantic user profiles (e.g., context-independent, context-dependent, or temporal, etc.). The differences between these profiles are described with further reference to FIG. 7. Additional types of semantic user profiles are contemplated and are considered within the scope of this disclosure.

The search/share module 807 can be any combination of software agents and/or hardware modules able to facilitate intelligent searching and sharing of objects, nets, contacts among users in the knowledge networking platform. Since relationships between objects (e.g., users, user profiles, items, contact information, nets) in a net associated with the networking platform are known and/or otherwise identifiable, advanced search functionalities can thus be provided in the knowledge networking environment. For example, since content is typically associated with users (e.g., by virtue of the content being added by users, content having commented on by users, and/or content having been edited by users), a search parameter enables a search user to specify the degree of separation within which to perform the search query. For example, a user may wish to see content related to ‘scuba diving’ associated with (e.g., posted by, commented by, moderated by, edited by, tagged by, rated by, and/or annotated by, etc.) users and/or contacts that are within three degrees of separation from the user.

In addition, the search parameter may allow the search user to specify the types of relationships within which to conduct the search. For example, a patent attorney may wish to see posted content related to new rules published by the United States Patent and Trademark Office that is associated with colleagues who are patent attorneys from the same law firm as the search user, and/or patent attorneys from a specified set of law firms. Further variations of utilizing identifiable relationships (semantic relationships, keyword relationships, etc.) between objects in the web-space to provide users with the ability to specify a targeted search scope are contemplated and considered to be within the scope of this novel disclosure.

Some search parameters include, by way of example but not limitation, search all available nets, search all content viewable only to me in a net, search all content viewable by members in a net, search content in a particular net, search all available nets, search nets including those I don't belong to, search nets associated with my connections, search nets associated with friends, search nets associated with colleagues, etc. Further, users can specify to search nets having tagged with specific tags (e.g., dogs, scuba, sharks, etc.). In addition, multiple search parameters are typically supported for further refining the search scope to one or more different types of relationship. For example, users can select to search and/or post to nets that are within a specified social distance from the user. In a further example, users can specify to search nets of first degree friends and are members of the DogLover's Net and are friends of Joe.

Similar to searching, when posting and/or otherwise sharing content, users can specify a targeted set of audience (e.g., users and nets). Some post parameters include, by way of example but not limitation, post to the user's net, post to the owner (or administrators) of a net, post to members of a net, post to a net but make viewable by public, post to second degree contacts that are employed by a particular company, post to nets of friends, post to nets of colleagues, post to nets that the user belongs to, post to nets having a predetermined set of tags identified, etc.

In some embodiments, the search/share module 807 is further able to provide enhanced recommendations to users, for example, users that opt-in to receive recommendations from the system and/or other users. In other words, the search/share module 807, in some embodiments, provides push-model based sharing. Since the knowledge networking environment, based on a user's profile, history, objects, nets, friends, etc., can deduce types of content and/or subject matter that the user is likely to be interested in, the search/share module 807 can present a list of objects/items likely to be of interest to the user. Furthermore, recommendations can be made based on a user's semantic profile which weights how interested in a particular topic a user is. This weight is, in one embodiment, determined from proximity to other entities in the networking environment.

In addition to user browsing history, recommendations can be made based on search history and items/web-pages the user is currently viewing or other information that is in the context-dependent semantic user profile. However, depending on the owner of the recommended objects/items, the user may or may not have immediate access. For example, item/object owners can specify to have objects be partially visible (e.g., title, summary, and/or abstract) to other users who do not have default access to the owner's items (e.g., they are not connected, they are not related, they are not friends, their social distance is not within a predetermined degree of separation, etc.).

If the user determines, for example, based on the partial visibility that the item is of interest, the search/share module 807, provides a pathway for the user to request the owner for access to the particular item of interest. Upon receiving an authorization from the owner, the search/share module 807 can present the requested items to the user. In other embodiments, recommended items are immediately available for access to the user if the owner does not have restricted privacy settings. Note that recommendations and sharing need not necessarily occur between users that are connected in any specified manner, if at all. Recommendations can be made by virtue of owners of items allowing their items to be at least partially shared and recipients who opt in to receive recommendations. In addition, sharing between users not initially connected provides an avenue through which to meet other users and/or to become connected in the network, for example.

The proximity module 808 can be any combination of software agents and/or hardware modules able to determine the social distance between objects in the knowledge networking environment. In general, social distance is proportional to the degrees of separation that an entity is from a particular user. For example, an entity with a one degree of separation is a user that is directly connected to the user of interest. A second degree contact is a direct connection of a first degree entity of the user that is not directly connected to the user. Since entities in the knowledge networking platform are associated with users (e.g., owners that added (posted) an item, edited an item, commented on an item, tagged an item, etc.), social distances can be determined between entities and other users.

Some example relationships (e.g., social relationships, semantic relationships, and/or social semantic relationships) between entities (e.g., objects, nets, and users) are illustrated semantic graphs of FIG. 4A-B. Further, the proximity module 808 is, in some embodiments, able to track semantic relationships between objects. In one embodiment, the proximity module 808 identifies a semantic relationship between a user's profile and another user's object. By identifying such relationships among the set of objects and users in the knowledge networking environment, social distances between objects and users can be determined.

Thus, in one embodiment, the proximity module 808 communicates with the search/share module 807 to facilitate in performing searching and sharing functions to be carried out within a particular scope of proximity. For example, the proximity module 808 can provide a list of users that satisfy a set of search criteria specified by a search user and the search/share module 807 performs a search on nets and items associated with the list of users. The search criteria, as detailed previously, can be a particular social distance, a range of social distances, a particular type of relationship, and/or a combination of any of the above. In some embodiments, the functions represented by the proximity module 808 and the search/share module 807 are partially and/or wholly combined and can be implemented with one or many modules.

In some embodiments, search results are provided to a search user in a format that indicates the social distance of each search result to the user, via a collaborative effort between the search/share module 807 and the proximity module 808. In a further embodiment, search results are ranked based on the degree of separation between the search user and the items in the search results. For example, in addition to keyword relevance and/or semantic relation, ranking of search results can factor in social distance.

In one embodiment, the proximity module 808 includes the semantic social linking module (not shown). The semantic social linking module can be any combination of software agents and/or hardware modules able to identify relationships between users based on semantic/keyword relationships between items/nets associated with the users. In most instances, the explicit relationships are identified based on user-triggered events whereas the implicit relationships are identified based on links (e.g., social, semantic, keyword, semantic social) determined by the knowledge networking environment, such as the metadata generator module 810.

The proximity module 808 communicates with the model analyzer module 806 to determine the proximity distance between the model user and the entities (e.g., referenced entities) in the model profile. In addition, the proximity module 808 further communicates with the profile generator module 812 to determine the proximity between any given user and an entity in the networking environment that the user is related to. In one embodiment, the proximity module 808 creates a semantic graph (e.g., the semantic graph of FIG. 4A-B) for any given semantic user profile and model profile to determine proximity.

For example, the proximity module 808 may assign relative probabilities to each relationship a user has with entities of varying degrees of separation. The probabilities of the relationships of each degree of separation are normalized to sum to one to obtain the absolute probability. The proximity between a central entity and a target entity is the product of the probabilities of all the possible pathways that the central entity can be linked to the target entity based on relationships in the network. Each pathway generally comprises of relationships of varying degrees from the central entity. An example process for computing proximity distance between a user or model user with referenced entities in the semantic profiles is described with further reference to FIG. 4A-B.

The comparison module 814 can be any combination of software agents and/or hardware modules that is able to retrieve and compare information gleaned from a semantic user profile and a model profile. The comparison module 814 can also generate a indicator (e.g., a correlation index) to indicate the degree of correlation between the model profile and the semantic user profile. The comparison module 814, in some embodiments, detects same or related entities (e.g., referenced entities) between a semantic user profile and the model profile by comparing model user metadata and user metadata. When identical or related entities are detected, the correlation index may be adjusted (e.g., increased) to represent the increase in correlation between the profiles.

In addition, when a relationship (e.g., social relationship or semantic relationship) is detected between an entity in the model user metadata and an entity in the user metadata, the correlation index may also be increased. Proximity distance of the relationship may be determined and used to further adjust the correlation to indicate an increase or decrease in correlation. In one embodiment, proximity information is received from the proximity module 808. Alternatively, proximity information may be determined or estimated by the comparison module 814.

In one embodiment, when same or related types of relationships are detected from the model profile and a semantic user profile but for different referenced entities, the correlation index is adjusted to indicate an increase in the degree of correlation. For example, when the model user and a user both like to travel, even though metadata indicates that they like to travel to different locations, the correlation between the user who likes to travel and the model user with a specified characteristic of liking to travel is increased regardless of where they like to travel to. Furthermore, if the model user likes to watch movies and a particular user likes to watch movies, their correlation may be increased regardless of what types of movies each prefers.

However, when substantially opposite or unrelated types of relationships are detected from the model profile and a semantic user profile, the correlation may contrastingly be adjusted to indicate a decrease in correlation index. For example, if the model user likes to watch TV but the user does not like to watch TV, the correlation between the user and the model user is can be decreased regardless of watch the TV show that one prefers to watch or the TV show that one does not prefer to watch.

In one embodiment, when model user metadata related to non-ideal user characteristics are identified in a user, the correlation index is adjusted to indicate a decrease in the degree of correlation. For example, if the model user is specified to dislike watching television, the correlation for a user who likes to watch television is adjusted to indicate a decrease in the degree of correlation.

Multiple sets of metadata for a particular user can be compared with the sets of metadata for the model user to generate a cumulative correlation index for the particular user. Once the cumulative correlation index has been determined for a multiple users, a suggestion of suitable users to be targeted can be made to the advertiser or the sponsor.

In the example of FIG. 8, the network interface 818 can be one or more networking devices that enable the host server 800 to mediate data in a network with an entity that is external to the host server, through any known and/or convenient communications protocol supported by the host and the external entity. The network interface 818 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

A firewall, can, in some embodiments, be included to govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure. In some embodiments, the functionalities of the network interface 818 and the firewall are partially or wholly combined and the functions of which can be implemented in any combination of software and/or hardware, in part or in whole.

The network interface 818 includes a communications module or a combination of communications modules communicatively coupled to the network interface 818 to manage a one-way, two-way, and/or multi-way communication sessions over a plurality of communications protocols.

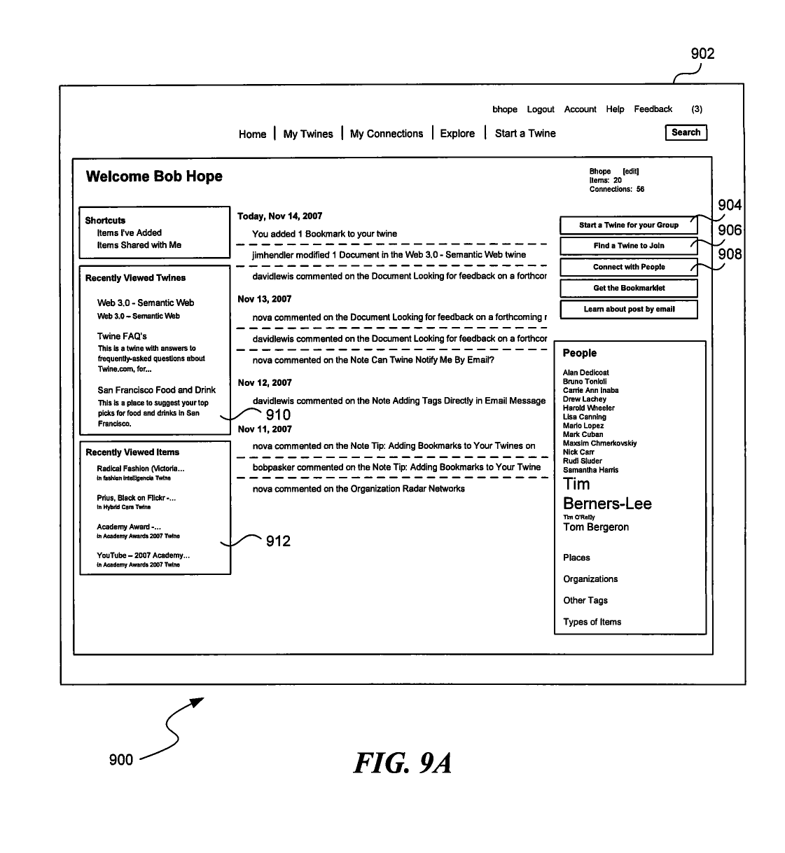

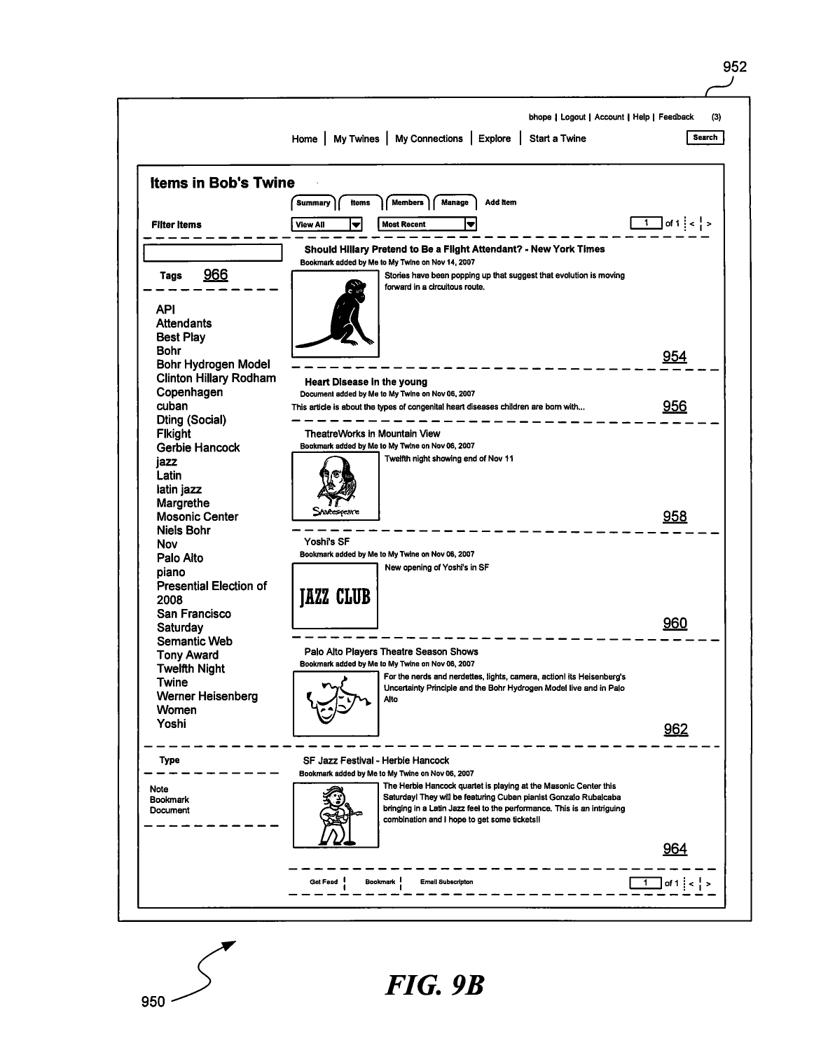

FIG. 9A illustrates an example screenshot 900 of a graphical user interface 902 for a user home page in the socially-enabled knowledge networking environment, including user connections, items, tags, and/or events, according to one embodiment.

The user welcome screen can be displayed when a user logs on to the knowledge networking environment. In the example shown, the user is able to view notifications indicating recent activities, including, but not limited to, other users that responded to a request made by the user. Requests placed to other users include invitations to join the network, invitation to join a group, and/or invitation to connect, etc. In addition, the home page, in most instances, displays request that the user has received from other users and/or groups. In one embodiment, the home page lists a log of the recent activities of the user. For example, the home page can display a list of pages recently visited, nets recently visited, recent comments, new connections made, new posts to nets, and/or new nets created by the user, etc. Additional functionalities and services associated with the home page is described with further reference to related application Ser. Nos. 11/874,881 and 11/874,882 both filed on Oct. 18, 2007 which is herein incorporated by reference.

Users can utilize the home page as a base for navigating to the various pages to manage items or connections with other users. For example, user nets can be viewed and accessed via the ‘My Twines’ tab and connections with other users can be managed via the ‘My connections’ tab. Nets (or Twines) can also be created via the “Start a Twine for your Group” button 904. Users can join nets via the button “Find a Twine to Join” 906 to join nets created by other users or user groups. Further, users can connect with other users on the network using the “Connect with People” button 908.

The nets that the user creates or joins via this home page become related ‘entities’ in the networking environment. Similar, the people that the user connects to also become entities. The entities and the types of relationships the user has with the entities become a basis under which user semantic profiles are created. The user semantic profile is generally constantly being updated as the user continues to engage in activities or participate in the network. Changes in net membership or changes in connections or types of connections can cause the semantic user profile (e.g., the context-independent component, the context-dependent component, or temporal component) to be modified accordingly.

The home page generally displays the user's recent activities, including but not limited to, recently viewed nets (Twines) in box 910 and/or recently viewed items in box 912. The recent activities such as those depicted on the home page can be a basis for which a temporal semantic user profiles (e.g., the temporal semantic user profile 703 in the example of FIG. 7) are created.

FIG. 9B illustrates an example screenshot 950 of a graphical user interface 952 displaying objects (items) in a user net in the networking environment, according to one embodiment.

The user interface 952 illustrates a set of items associated with one of user's (“Bob Hope”) nets. In this example, a list of various types of items 954-964 is displayed. Note that items that can be included in a net include, in addition to events, but are not limited to, contacts, web pages, videos, images, and/or articles, etc. In addition, a list of tags 966 that are detected in the particular net is displayed in the object view of the net. The number of tags to be displayed may be user specifiable. In addition, the visualization of the tags (e.g., the relative sizes, relative positions, colors, font, etc.) may also be user specifiable.

The user interface 952 provides to the user, an overview of a list of nets (“Twines®”) associated with the user. For example, the nets can be displayed as results of a search query. The nets can also be displayed based on identified proximity between the net and the user. The exploration view of various nets, also, in some embodiments, enables the user to join a net. In addition, the net exploration view can also enable a user to request membership in a net where membership is restricted and/or where approval is required.

The items added to the user's net (“Bob's Twine”) become entities having the same type of relationship (e.g., the relationship <has item>) with the user. These items in a user's net also become entities that make up the user's semantic profile. Similarly, user access of these items in the net also becomes entities that are a component of the user's semantic profile. Furthermore, the list of tags 966 identified from the items in the user net can be used to further enrich the user semantic profile. For example, the strength of each tag can be determined based its frequency of occurrence in a semantic profile. In one embodiment, proximity distance computation may factor into relative or absolute tag strengths.

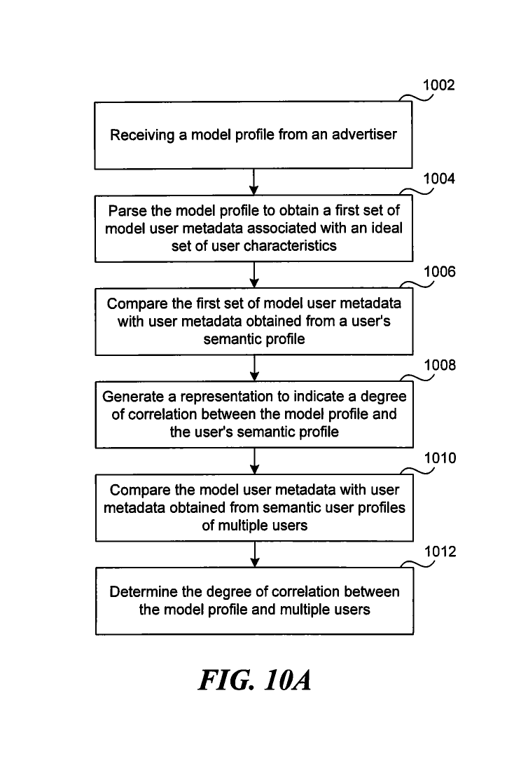

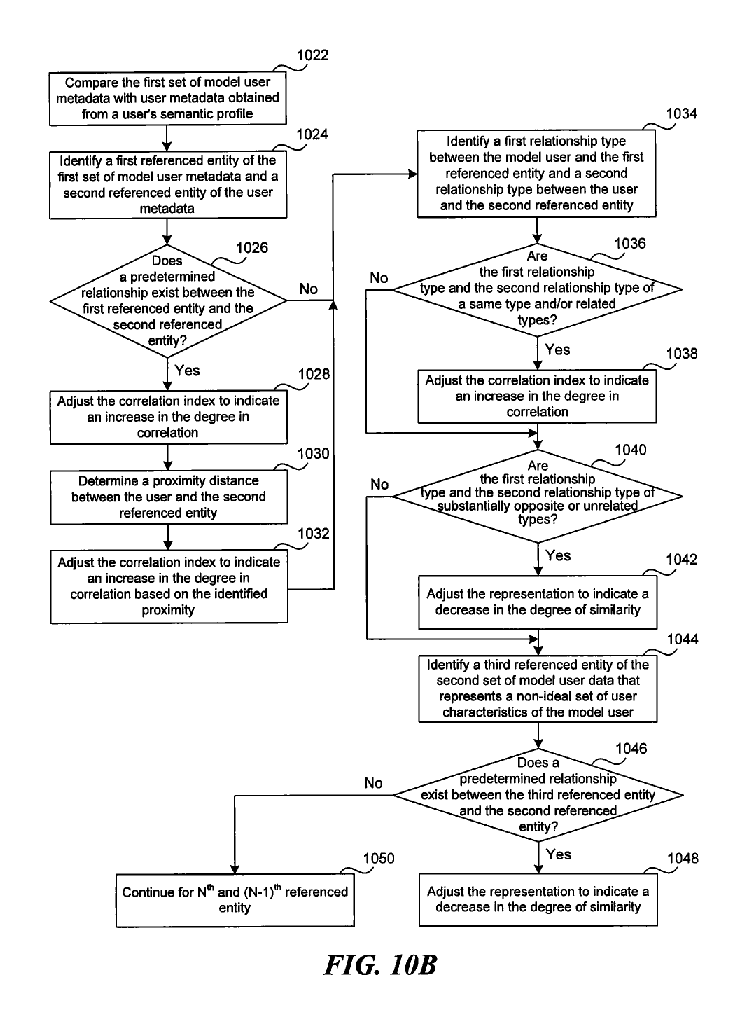

FIG. 10A depicts a flow diagram illustrating an example process of determining the degree of correlation between a model profile and a semantic user profile, according to one embodiment.

In process 1002, a model profile is received from an advertiser. In process 1004, the model profile is parsed to obtain a first set of model user metadata associated with an ideal set of user characteristics. In process 1006, the first set of model user metadata is compared with user metadata obtained from a user's semantic profile. In process 1008, a representation to indicate a degree of correlation between the model profile and the user's semantic profile is generated.

In process 1010, the model user metadata is compared with user metadata obtained from semantic user profiles of multiple users. In process 1012, the degree of correlation between the model profile and multiple users is determined.

FIG. 10B depicts a flow diagram illustrating an example process for determining a correlation index that indicates the degree of correlation between the model profile and the semantic user profile, according to one embodiment.

In process 1022, the first set of model user metadata is compared with user metadata obtained from a user's semantic profile. In process 1024, a first referenced entity of the first set of model user metadata and a second referenced entity of the user metadata are identified. In process 1026, it is determined whether a predetermined relationship (e.g., semantic relationship and/or social relationship) exists between the first referenced entity and the second referenced entity. If the predetermined relationship exits, in process 1028, the correlation is adjusted to indicate an increase in the degree of correlation.

In process 1030, a proximity distance between the user and the second referenced entity is determined. In process 1032, the correlation is adjusted to indicate an increase in the degree of correlation based on the identified proximity. If a predetermined relationship does not exist, in process 1034, a first relationship type between the model user and the first referenced entity is identified. In addition, a second relationship type between the user and the second referenced entity is identified. In process 1036, it is determined whether the first relationship type and the second relationship type are of same or related types. If the same or related types are detected, in process 1038, the correlation is adjusted to indicate an increase in the degree of correlation.

If the same or related types are not detected, in process 1040, it is determined whether the first relationship type and the second relationship type are substantially opposite. If so, in process 1042, the correlation is adjusted to indicate a decrease in the degree of correlation. In process 1044, a third referenced entity of the second set of model user data that represents a non-ideal set of user characteristics of the model user is identified. In process 1046, it is determined if a predetermined relationship exists between the third referenced entity and the second referenced entity. If so, in process 1048, the correlation index is adjusted to indicate a decrease in the degree of correlation.

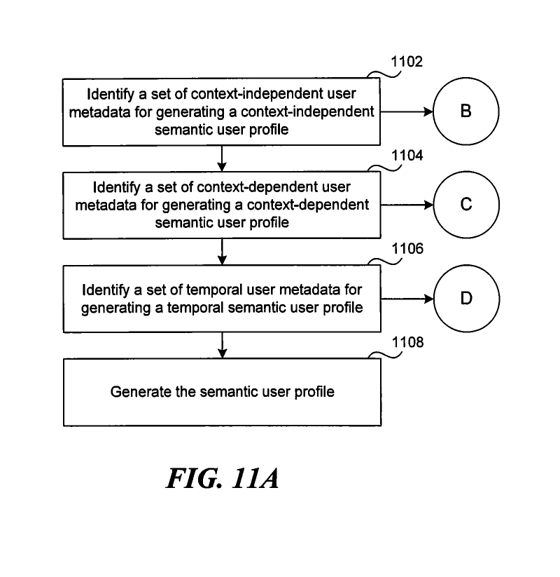

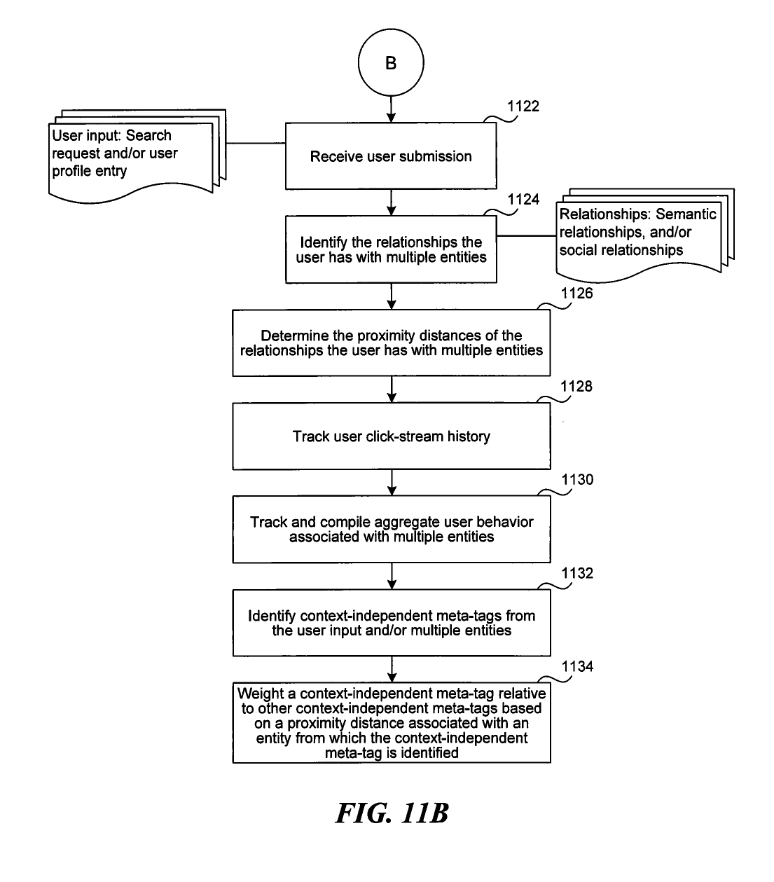

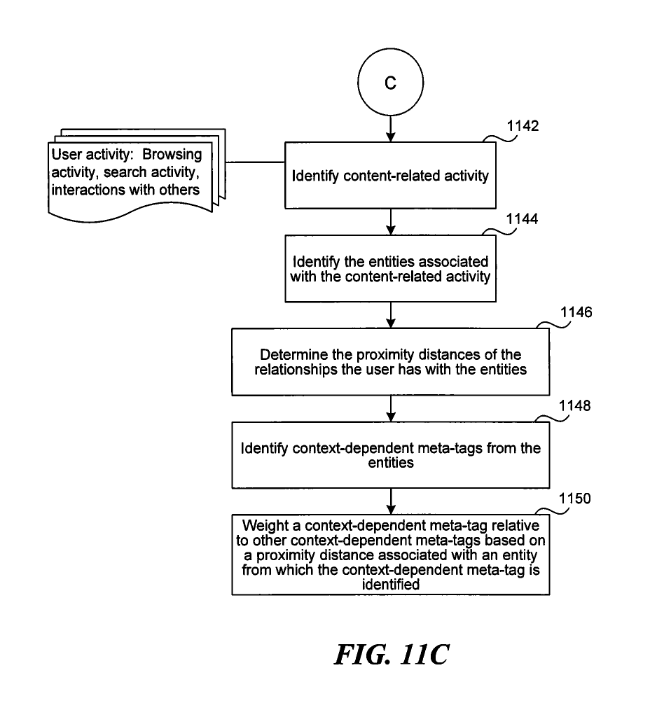

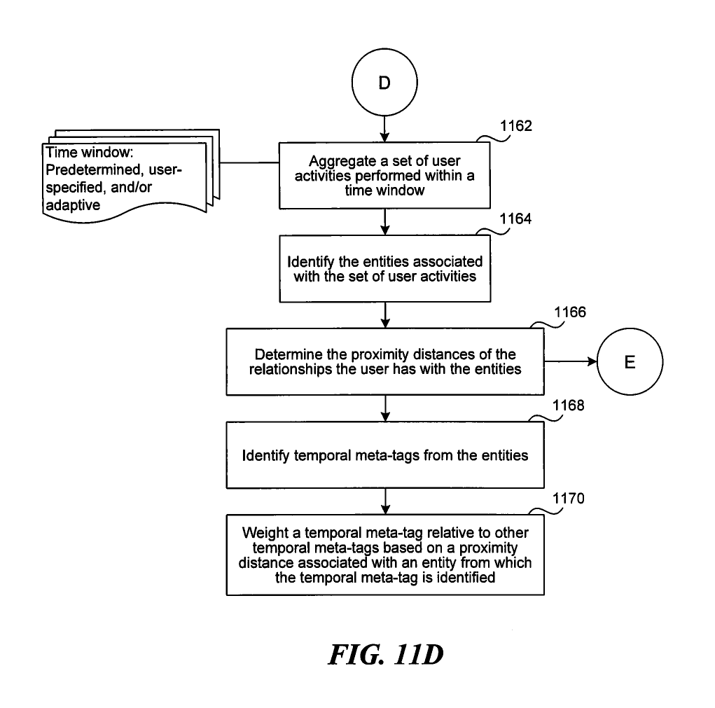

FIG. 11A depicts a flow diagram illustrating an example process for generating a semantic user profile, according to one embodiment.

In process 1102, a set of context-independent user metadata for generating a context-independent semantic user profile is identified. The set of context-independent metadata can be identified for example, with further reference to FIG. 11B. In process 1104, a set of context-dependent user metadata for generating a context-dependent semantic user profile is identified. The set of context-dependent metadata can be identified with the example process of FIG. 11C. In process 1106, a set of temporal user meta-data for generating a temporal set semantic user profile is identified. The temporal user metadata can be identified via the example process of FIG. 11D.

In process 1108, the semantic user profile is generated from one or more of the context-independent semantic user profile, the context-dependent user profile, and the temporal semantic user profile.

FIG. 11B depicts a flow diagram illustrating an example process for generating a context-independent semantic user profile, according to one embodiment.

In process 1122, user submission is received. User submission may be in the form of a search request and/or in the form or a user profile entry. In process 1124, the relationships (e.g., semantic and/or social relationship) the user has with multiple entities are identified. In process 1126, user click-stream history is tracked. In process 1130, aggregate user behavior associated with multiple entities is tracked and compiled. In process 1132, context-independent meta-tags are identified from the user submission and/or the multiple entities. In process 1134, a context-independent meta-tag is weighed relative to other context-independent meta-tags based on a proximity distance associated with an entity from which the context-independent meta-tag is identified.

FIG. 11C depicts a flow diagram illustrating an example process for generating a context-dependent semantic user profile, according to one embodiment.

In process 1142, context related activity that a user is currently engaged in through a web-browser is identified. For example, user activities can include, browsing activity, searching activity, and/or interactions with others. In process 1144, the entities associated with context-related activity are identified. In process 1146, the proximity distances of the relationships the user has with the entities are determined. In process 1148, context-dependent meta-tags from are identified the entities. In process 1150, a context-dependent meta-tag is weighed relative to other context-dependent meta-tags based on a proximity distance associated with an entity from which the context-dependent meta-tag is identified.

FIG. 11D depicts a flow diagram illustrating an example process for generating a temporal semantic user profile, according to one embodiment.

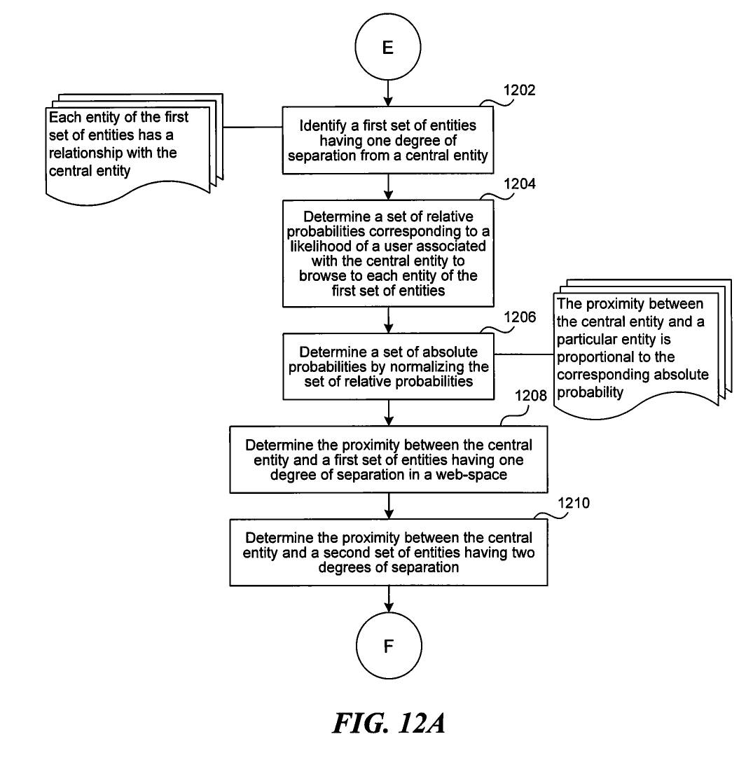

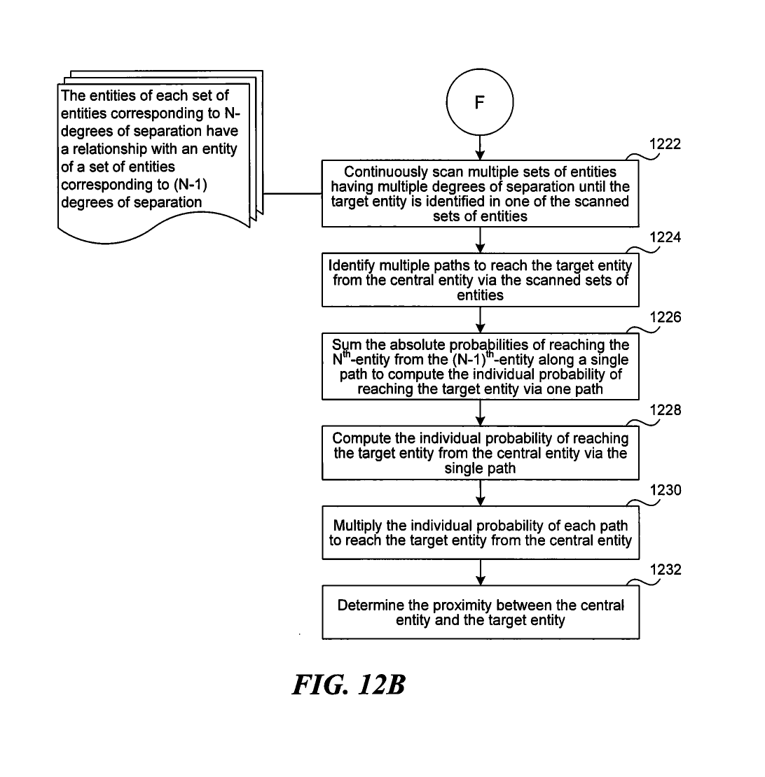

In process 1162, a set of user activities performed in the web-based environment within a time window is aggregated. In process 1164, the entities associated with the set of user activities are identified. In process 1166, the proximity distances of the relationships the user has with the entities are determined. Proximity distances may be determined with further reference to the process of FIG. 12A.

In process 1168, temporal meta-tags are identified from the entities. In process 1170, a temporal meta-tag is weighed relative to other temporal meta-tags based on a proximity distance associated with an entity from which the temporal meta-tag is identified.

FIG. 12A-B depict a flow diagrams illustrating an example process of determining proximity between a central entity and a target entity, according to one embodiment.

In process 1202, a first set of entities having one degree of separation from a central entity is identified. Each entity of the first set of entities has a relationship (e.g., semantic and/or social) with the central entity. In process 1204, a set of relative probabilities corresponding to a likelihood of a user visiting the central entity to view each entity of the first set of entities is determined. In process 1206, a set of absolute probabilities is determined by normalizing the set of relative probabilities to sum up to one. The proximity between the central entity and a particular entity is proportional to the corresponding absolute probability. In process 1208, the proximity between the central entity and a first set of entities having one degree of separation in a web-space is determined. In process 1210, the proximity between the central entity and a second set of entities having two degrees of separation is determined.

In process 1222, multiple sets of entities having multiple degrees of separation are scanned continuously until the target entity is identified in one of the scanned sets of entities. The entities of each set of entities corresponding to N-degrees of separation to have a relationship with an entity of a set of entities corresponding to (N-1) degrees of separation. In process 1224, multiple paths to reach the target entity from the central entity are identified via the scanned sets of entities. In process 1226, the absolute probabilities of reaching the N^{th}-entity from the (N-1)^{th}-entities along a single path are multiplied to obtain the individual probability of reaching the target entity via one path.

In process 1228, the probability of reaching the target entity from the central entity via a single path is computed. In process 1230, the individual probability of each path to reach the target entity from the central entity is multiplied. In process 1232, the proximity between the central entity and the target entity can be determined.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other methods, devices, and/or systems, not necessarily to those described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the device may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated.

In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. Accordingly, the inventors reserve the right to add additional claims after filing the application to pursue such additional claim forms for other aspects of the disclosure.

What is claimed is:

1. A method of advertisement optimization via semantic profiles, comprising:
receiving a model profile from an advertiser, the model profile represents an ideal set of user characteristics of a model user specified by the advertiser;
parsing the model profile to obtain a first set of model user metadata associated with the ideal set of user characteristics;
comparing model user metadata of the first set of model user metadata with user metadata of a set of user metadata of a semantic user profile of a user; and
generating a correlation index to indicate a degree of correlation between the model profile and the semantic user profile.

2. The method of claim 1, further comprising, identifying a first referenced entity of the first set of model user metadata and a second referenced entity of the user metadata.

3. The method of claim 2, further comprising, adjusting the correlation index to indicate an increase in the degree of correlation responsive to, identifying that a predetermined relationship exists between the first referenced entity and the second referenced entity.

4. The method of claim 2, wherein the first referenced entity is the same entity as the second referenced entity.

5. The method of claim 2, further comprising, determining a proximity distance between the user and the second referenced entity and further adjusting the correlation index to indicate an increase in the degree of correlation based on the identified proximity.

6. The method of claim 5, wherein the increase in degree of correlation is associated with a smaller proximity distance between the user and the second referenced entity.

7. The method of claim 2, further comprising:
identifying a first relationship type between the model user and the first referenced entity based on the model user metadata; and
identifying a second relationship type between the user and the second referenced entity based on the user metadata.

8. The method of claim 7, further comprising, adjusting the correlation index to indicate an increase in the degree of correlation responsive to, determining that the first relationship type and the second relationship type are of a same type or related types.

9. The method of claim 7, further comprising, adjusting the correlation index to indicate a decrease in the degree of correlation responsive to, determining that the first relationship type and the second relationship type are of substantially opposite or unrelated types.

10. The method of claim 1, wherein the model profile further comprises a second set of model user metadata that represents a non-ideal set of user characteristics of the model user specified by the advertiser.

11. The method of claim 10, further comprising, adjusting the correlation index to indicate a decrease in the degree of correlation responsive to, identifying the predetermined relationship between a third referenced entity of the second set of model user data and the second referenced entity of the user metadata.

12. The method of claim 10, further comprising, comparing model user metadata of the set of model user data with user metadata of a plurality of semantic user profiles associated with a plurality of users and determining the degree of similarities between the model profile and the plurality of users.

13. A method of generating a semantic user profile, comprising:
identifying context-independent user metadata for generating a context-independent semantic user profile;
identifying context-dependent user metadata for generating a context-dependent semantic user profile;
identifying temporal user meta-data for generating a temporal semantic user profile; and
generating the semantic user profile from at least one of the context-independent semantic user profile, the context-dependent semantic user profile, and the temporal semantic user profile.

14. The method of claim 13, further comprising, generating the semantic user profile from at least two of the context-independent semantic user profile, the context-dependent semantic user profile, and the temporal semantic user profile.

15. The method of claim 14, wherein the relative weight of the at least two of the context-independent semantic user profile, the context-dependent semantic user profile, and the temporal semantic user profile when generating the semantic user profile is represented by a weighing factor associated with each of the semantic user profiles.

16. The method of claim 15, wherein the weighing factor is one or more of, predetermined, determined on-demand, and adaptive.

17. The method of claim 13, wherein the identifying the context-independent user metadata comprises:
receiving user submission;
identifying a plurality of relationships the user has with a plurality of entities; wherein the plurality of entities comprises one or more of, tangible, intangible and software entities; and
tracking and compiling aggregate user behavior associated with the plurality of entities.

18. The method of claim 17, further comprising, identifying a set of context-independent meta-tags from one or more of, the user input and the plurality of entities.

19. The method of claim 17, wherein the user submission comprises one or more of, a user-generated search request and a user profile entry.

20. The method of claim 17, wherein the plurality of relationships comprises semantic relationships and social relationships.

21. The method of claim 17, further comprising, tracking user click-stream activity to track and compile data related to aggregate user behavior.

22. The method of claim 20, further comprising, determining the proximity between each of the plurality of entities and the user based on the plurality of relationships.

23. The method of claim 22, further comprising, weighing a context-independent meta-tag of the set of context-independent meta-tags relative to other context-independent meta-tags based on, proximity associated with an entity of the plurality of entities from which the context-independent meta-tag is identified.

24. The method of claim 13, wherein the identifying the context-dependent user metadata comprises:
identifying context-related activity in a web-based environment that the user is currently engaged in through a web-browser;
identifying a first set of entities of the plurality of entities in the web-based environment associated with the context-related activity; and
identifying a set of context-dependent meta-tags from the first set of entities.

25. The method of claim 24, wherein context-related activity, comprises, one or more of, a web-page the user is currently viewing, an email the user is currently reading, a search the user is currently performing, a soundtrack the user is currently listening to, and a video the user is currently watching.

26. The method of claim 13, wherein the identifying the set of temporal user metadata comprises:
aggregating a set of user activity performed in the web-based environment through the web-browser within a time window;
identifying a second set of entities of the plurality of entities in the web-based environment associated with the set of user activity; and
identifying a set of temporal meta-tags from the second set of entities.

27. The method of claim 26, wherein the time window is one or more of, predetermined, user-specified, and adaptive.

28. The method of claim 27, wherein the time window is, session based, weekly-based, hourly-based, and monthly-based.

29. A method of generating a context-independent semantic user profile in a web-based environment for a user, comprising:
receiving explicit user input from the user via web-submission;
identifying a plurality of relationships the user has with a plurality of entities in the web-based environment; wherein the plurality of entities comprises one or more of, tangible, intangible and software entities; and
tracking user click-stream history to track and collect data related to aggregate user behavior in the web-based environment.

30. The method of claim 29, further comprising, identifying a set of context-independent meta-tags from one or more of, the explicit user input and the plurality of entities.

31. The method of claim 29, wherein the explicit user input comprises one or more of, a user-generated search request and a user profile entry.

32. The method of claim 29, wherein the plurality of relationships comprises semantic relationships.

33. The method of claim 29, further comprising, determining the proximity between each of the plurality of entities and the user based on the plurality of relationships.

34. A method of generating a context-dependent semantic user profile, comprising:
identifying context-related activity in a web-based environment that the user is currently engaged in through a web-browser;
identifying a first set of entities of the plurality of entities in the web-based environment associated with the context-related activity; and
identifying a set of context-dependent meta-tags from the first set of entities.

35. A method of generating a temporal semantic user profile, comprising:
aggregating a set of user activity performed in the web-based environment through the web-browser within a time window;
identifying a second set of entities of the plurality of entities in the web-based environment associated with the set of user activity; and
identifying a set of temporal meta-tags from the second set of entities.

36. The method of claim 35, wherein the time window is one or more of, predetermined, user-specified, and adaptive.

37. A method of determining proximity between entities in a web-space, comprising:
identifying a first set of neighboring entities having one degree of separation from a central entity, each of the first set of entities have a relationship with the central entity; wherein the relationship is one of a plurality of types;
determining a set of relative probabilities corresponding to a likelihood of a user associated with the central entity to browse to each of the first set of entities, the set of relative probabilities to be determined based on a type of relationship between each of the first set of entities and the central entity;
computing a set of absolute probabilities by normalizing the set of relative probabilities such that the sum of the absolute probabilities of the user associated with the central entity to browse to each of the first set of entities is substantially one;
wherein the proximity between the central entity and each of the first set of entities is proportional to a corresponding absolute probability of the set of absolute probabilities.

38. The method of claim 37, further comprising, determining the proximity between the central entity and a second set of neighboring entities having two degrees of separation, each of the second set of neighboring entities have a relationship with the central entity.

39. The method of claim 38, further comprising, determining the proximity between the central entity and a target entity, wherein the determining further comprises:
continuously scanning pluralities of sets of entities having one or more degrees of separation from the central entity until the target entity is identified in one of the scanned pluralities of sets of entities;
wherein each entity of the pluralities of the sets of entities having N-degrees of separation from the central entity have a relationship with at least one entity of a set of entities with (N-1) degrees of separation;
identifying a plurality of paths defined by relationships to reach the target entity from the central entity via the scanned pluralities of sets of entities;
computing individual probability of reaching the target entity from the central entity via a path of the plurality of paths by multiplying the absolute probabilities of browsing to the N^{th}-entity from the (N-1)^{th}-entities along the path of the plurality of paths; and
summing the individual probability of each path of the plurality of paths to reach the target entity from the central entity to determine the proximity between the central entity and the target entity.

40. The method of claim 37, wherein the relationship comprises a plurality of semantic relationships; wherein the plurality of semantic relationships are of a plurality of types.

41. The method of claim 37, wherein the relationship comprises social links.

42. The method of claim 40, wherein a first type of semantic relationship differs in relative probability from a second type of semantic relationship.

43. The method of claim 37, wherein the web-space comprises one or more web-based networking environments.

44. The method of claim 37, wherein an entity includes one or more of a user, a net, and an item in the web-space.

45. The method of claim 44, wherein the item is an intangible entity, a tangible entity, or a software entity.

46. A system, comprising:
a model analyzer module to receive a model profile from an advertiser, the model profile represents a desired set of user characteristics of a model user specified by the advertiser;
a parser module communicatively coupled to the model analyzer module, when, in operation, the parser module establishes a communication session with the model analyzer and parses the model profile provided by the model analyzer module to obtain a first set of model user metadata associated with the desired set of user characteristics;
a user database to store a set of user metadata of a semantic user profile of a user;
a comparison module communicatively coupled to the user database and the parser module, when in operation, the comparison module establishes a communication session with the parser module to retrieve the model user metadata and to compare model user metadata of the set of model user metadata with user metadata of a set of user metadata of a semantic user profile of a user; and
a matching module communicatively coupled to the comparison module to generate a correlation index to indicate a degree of correlation between the model profile and the semantic user profile.

47. A system for generating a semantic user profile, comprising:
a communications module, when, in operation, establishes a communication session with a user to receive user input;
a tracking module for tracking a set of user activity;
a metadata generator module communicatively coupled to the tracking module, when, in operation, the metadata generator module identifies a set of context-independent user metadata for generating a context-independent semantic user profile;
wherein, when, in operation, the metadata generator module identifies a set of context-dependent user metadata for generating a context-dependent semantic user profile;
a timing module communicatively coupled to the user tracking module, when, in operation, the timing module establishes a communication session with the user tracking module to track an amount of time user activity is being recorded;
wherein, when, in operation, the metadata generator module identifies a set of temporal user metadata for generating a temporal semantic user profile; and
a profile generator engine communicatively coupled to the metadata generator module for generating the semantic user profile from at least one of the context-independent semantic user profile, the context-dependent semantic user profile, and the temporal semantic user profile.

48. A system for semantic advertising, comprising:
means for, receiving a model profile from an advertiser, the model profile represents a desired set of user characteristics of a model user specified by the advertiser;
means for, parsing the model profile to obtain a first set of model user metadata associated with the ideal set of user characteristics;
means for, comparing model user metadata of the first set of model user metadata with user metadata of a set of user metadata of a semantic user profile of a user; and
means for, generating a correlation index to indicate a degree of correlation between the model profile and the semantic user profile.

49. A method of optimized targeted advertising based on semantic user profiles, comprising:
receiving a model profile from an advertiser, the model profile represents an ideal set of user characteristics of a model user to whom promotional content is to be presented;
generating a set of semantic user profiles for each of a set of users;
comparing the model profile and the set of semantic user profiles;
generating a set of correlation index for indicating the degree of correlation between the model user and the set of users; and
identifying a sub-set of the set of users as candidates to whom the promotional content is to be presented.
